(19) United States
(12) Patent Application Publication
(10) Pub. No.: US 2009/0086369 A1
(43) Pub. Date: Apr. 2, 2009

(54) MAGNETIC RECORDING MEDIUM, MAGNETIC SIGNAL REPRODUCTION METHOD AND MAGNETIC SIGNAL REPRODUCTION SYSTEM

(75) Inventors: Junpei ISHIDA, Kanagawa (JP); Yutaka Kakuishi, Kanagawa (JP); Katsuhiko Meguro, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/240,450

(22) Filed: Sep. 29, 2008

(30) Foreign Application Priority Data
Sep. 28, 2007 (JP) 2007-256861

(51) Int. Cl. G11B 5/127; G11B 5/708; G11B 5/33

(52) U.S. Cl. 360/110; 428/842; 428/810; G9B/5.271; G9B/5.104; G9B/5.04

(57) ABSTRACT

An aspect of the present invention relates to a magnetic recording medium comprising a magnetic layer comprising a ferromagnetic powder and a binder on one surface of a nonmagnetic support and a backcoat layer on the other surface of the nonmagnetic support, wherein a number of indentations equal to or greater than 20 nm in depth present on the magnetic layer surface is equal to or less than 100/10,000 μm², a sol component ratio in the magnetic layer is equal to or less than 5.0 percent, and the support has an amount of heat absorption based on enthalpy relaxation ranging from 0.5 J/g to 2.0 J/g, and a glass transition temperature Tg ranging from 110° C. to 140° C. The present invention further relates to a method of reproducing magnetic signals and magnetic signal reproduction system in which the magnetic recording medium is employed.

### CROSS-REFERENCE TO RELATED APPLICATIONS

This application claims the benefit of priority under 35 USC 119 to Japanese Patent Application No. 2007-256861 filed on Sep. 28, 2007, which is expressly incorporated herein by reference in its entirety.

### BACKGROUND OF THE INVENTION

1. Field of the Invention

The present invention relates to a magnetic recording medium, more particularly, to a magnetic recording medium exhibiting good electromagnetic characteristics and having dimensional stability over extended periods, and to a magnetic signal reproduction method and magnetic signal reproduction system employing the magnetic recording medium.

2. Discussion of the Background

With the widespread use of personal computers, work stations, and the like in recent years, a large amount of research has been conducted in the field of magnetic tapes into magnetic recording media for use in recording computer data as external recording media. In the course of putting such magnetic recording media to practical use, a strong need has developed for greater recording capacity to achieve recording devices of greater capacity and smaller size. This has been particularly true in conjunction with reducing computer size and increasing information processing capability.

Thus, reproduction heads operating on the principle of magnetoresistance (MR) have been proposed. The use of such reproduction heads in hard disks and the like has already begun, and their application to magnetic tapes has been proposed. Since MR heads can achieve a reproduction output of several times that of inductive magnetic heads and do not employ induction coils, device noise such as impedance noise can be greatly reduced. By reducing the noise of the magnetic recording medium, it becomes possible to achieve a high S/N ratio. In other words, by reducing the magnetic recording medium noise that is conventionally concealed by device noise, good recording and reproduction can be conducted and a major advance can be made in high-density recording characteristics.

In the field of data backup tapes, as the capacity of the hard disks being backed up has increased, products with recording capacities of 800 GB or more per roll have been developed. To respond to future increases in the capacity of hard disks, the achievement of high capacity in backup tapes will be essential. Means of increasing the capacity of a roll of backup tape include increasing the length of tape per roll by reducing the overall thickness of the tape, reducing thickness loss and shortening the recording wavelength by reducing the thickness of the magnetic layer, and increasing the recording density in the width direction by narrowing the track width.

To achieve higher recording density and greater recording capacity, the trend has been to narrow the track width during recording and reproduction of the magnetic recording medium. In the field of magnetic tapes, reduction in the thickness of the magnetic tape has continued to permit high recording densities. A large number of magnetic tapes with a total thickness of 10 micrometers or less have appeared. However, when the thickness of the magnetic recording medium is reduced, the magnetic recording medium tends to be affected by changes in tension, temperature and humidity during storage and running.

That is, during recording and reproduction in a magnetic recording and reproduction system employing a linear recording method, the magnetic head must be displaced in the width direction of the magnetic tape to select one of tracks. However, as the track width narrows, great precision becomes necessary to control the position of the head relative to the magnetic tape. Even when the S/N ratio is improved and a narrow track width is achieved by using the above-described MR head and microgranular magnetic material, the temperature and humidity of the environment during use and fluctuation in tension in the drive may distort the magnetic recording medium, sometimes making it impossible for the reproduction head to read tracks that have been recorded. Thus, there is a need for a medium with greater dimensional stability than has been achieved thus far. Such a high-density magnetic recording medium is required to have greater dimensional stability than conventional media to maintain stable recording and reproduction. Japanese Unexamined Patent Publication (KOKAI) No. 2007-188613 or English language family member US 2007/0166571 A1, which are expressly incorporated herein by reference in their entirety, proposes a means of increasing dimensional stability by subjecting the nonmagnetic support to a prescribed heat treatment to relax the enthalpy due to the crystalline portion (=amorphous portion) therein, reducing heat absorption to below a prescribed value.

The recording wavelength has been shortened to increase recording density. When the recording wavelength is shortened, the effect of the spacing between the magnetic layer and the magnetic head increases. Thus, when indentations are present on the surface of the magnetic layer, spacing loss may cause the half peak width (PW 50) of the output peak to broaden, lowering output and increasing the error rate. When the track width is narrowed to increase the recording density in the width direction, the magnetic flux leaking from the magnetic recording medium decreases, requiring the use of a MR head capable of generating a high output even for a minute magnetic flux as the reproduction head. For example, Japanese Patent No. 3818581 or English language family member US 2004/0076855 A1, which are expressly incorporated herein by reference in their entirety, proposes a magnetic recording and reproduction system in which the number of indentations present on the magnetic layer surface with a depth of ⅓ or greater the minimum recording bit length be kept to 100/10,0001 μm² and the center average roughness SRa of the magnetic layer surface be kept to within a range of 1.0 to 6.0. As proposed in Japanese Patent No. 3818581, to reproduce with a good S/N ratio a signal that has been recorded at high density requires controlling the surface properties of the magnetic layer.

However, as the result of extensive research of the techniques described in Japanese Unexamined Patent Publication (KOKAI) No. 2007-188613 and Japanese Patent No. 3818581, the present inventors have discovered that the magnetic recording medium described in Japanese Unexamined Patent Publication (KOKAI) No. 2007-188613 does not necessarily achieve magnetic layer surface properties suited to high-density recording, and the magnetic recording medium described in Japanese Patent No. 3818581 does not necessarily adequately optimize production.

### SUMMARY OF THE INVENTION

An aspect of the present invention provides for a magnetic recording medium exhibiting good electromagnetic characteristics and having dimensional stability over extended periods, and affording good optimization of production.

An aspect of the present invention relates to a magnetic recording medium comprising a magnetic layer comprising a ferromagnetic powder and a binder on one surface of a nonmagnetic support and a backcoat layer on the other surface of the nonmagnetic support, wherein

a number of indentations equal to or greater than 20 nm in depth present on the magnetic layer surface is equal to or less than 100/10,000 1m²,

a sol component ratio in the magnetic layer is equal to or less than 5.0 percent, and

the support has an amount of heat absorption based on enthalpy relaxation ranging from 0.5 J/g to 2.0 J/g, and a glass transition temperature Tg ranging from 110° C. to 140° C.

The magnetic recording medium may have a heat shrinkage rate of equal to or less than 0.20 percent.

The magnetic recording medium may be a tape-shaped magnetic recording medium having a tape width change rate of equal to or less than 800 ppm.

The number of indentations equal to or greater than 20 nm in depth present on the magnetic layer surface may range from 2/10,000 μm² to 90/10,000 μm², and further, 2 /10,000 μm² to 70/10,000 μm².

The sol component ratio in the magnetic layer may be equal to or less than 3.0 percent.

A further aspect of the present invention relates to a method of reproducing magnetic signals, comprising:

reproducing magnetic signals that have been recorded on the above magnetic recording medium with a reproduction head with a track width of equal to or less than 4.0 μm.

A still further aspect of the present invention relates to magnetic signal reproduction system, comprising:

the above magnetic recording medium, and a reproduction head with a track width of equal to or less than 4.0 μm.

The present invention can provide a magnetic recording medium exhibiting good electromagnetic characteristics (such as low dropout), good dimensional stability (such as little change in tape width in an operating environment and little change in tape width due to long-term storage), and good production optimization (little breakage during processing). The magnetic recording medium of the present invention can afford good running durability.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a schematic section view of an example of the magnetic recording medium of the present invention.

FIG. 2 is a manufacturing process diagram showing an example of the method of manufacturing a magnetic recording medium of the present invention.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Magnetic Recording Medium

The present invention relates to a magnetic recording medium comprising a magnetic layer comprising a ferromagnetic powder and a binder on one surface of a nonmagnetic support and a backcoat layer on the other surface of the nonmagnetic support. In the magnetic recording medium of the present invention, a number of indentations equal to or greater than 20 nm in depth present on the magnetic layer surface is equal to or less than 100/10,000 μm², a sol component ratio in the magnetic layer is equal to or less than 5.0 percent, and the support has an amount of heat absorption based on enthalpy relaxation ranging from 0.5 J/g to 2.0 J/g, and a glass transition temperature Tg ranging from 110° C. to 140° C.

Keeping the number of indentations equal to or greater than 20 nm in depth that are present on the surface of the magnetic layer to equal to or less than 100/10,000 μm² in the magnetic recording medium of the present invention can reduce dropout and achieve good electromagnetic characteristics. Keeping the amount of heat absorption based on enthalpy relaxation in the support of the nonmagnetic support to equal to or greater than 0.5 J/g and equal to or less than 2.0 J/g can reduce dimensional change in the operating environment and during extended storage. Employing a nonmagnetic support with a glass transition temperature Tg of equal to or higher than 110° C. and equal to or lower than 140° C. can prevent breakage during processing and achieve good production optimization. Having a sol component ratio of equal to or less than 5.0 percent in the magnetic layer can reduce head grime during running. It is difficult to realize the above magnetic recording medium with the technique described in Japanese Unexamined Patent Publication (KOKAI) No. 2007-188613. This point is described below.

With the technique described in Japanese Unexamined Patent Publication (KOKAI) No. 2007-188613, there may be a large number of indentations on the magnetic layer surface, sometimes causing a drop in electromagnetic characteristics. As the result of investigation, the present inventors have discovered that these indentations is caused by the transfer of protrusions on the backcoat layer surface to the magnetic layer surface due to the heat treatment of the magnetic recording medium stock material while it is rolled up following calendering. Generation of these indentations can be prevented by not conducting the above heat treatment. However, the above heat treatment has the effect of promoting curing of the magnetic layer and thus reducing uncured material causing head grime during running, so it should not be eliminated if a good running property is to be achieved. Additionally, it is conceivable to conduct the heat treatment of the magnetic recording medium stock material while in web form, with the surface of the magnetic layer not in contact with the surface of the backcoat layer, but curing of the magnetic layer tends not to advance adequately when this is done.

Accordingly, the present inventors conducted extensive research, resulting in the discovery that the generation of indentations on the surface of the magnetic layer was prevented when the heat treatment to promote curing of the magnetic layer was conducted with the surface of the rolled up magnetic layer in contact with the surface of the backcoat layer by the methods described below, for example. The magnetic recording medium of the present invention having the above-stated physical properties was devised on that basis.
(1) Following the above heat treatment, treating the magnetic recording medium stock material that is being conveyed in web form either by heating or calendering to reduce the indentations.
(2) Designing the backcoat layer to be flexible so that protrusions on the surface of the backcoat layer are not transferred to the surface of the magnetic layer even when the heat treatment is conducted with the surface of the magnetic layer in contact with the surface of the backcoat layer.

Methods (1) and (2) above will be described in detail further below.

The magnetic recording medium of the present invention is described in greater detail below.

### I. Nonmagnetic Support

In the magnetic recording medium of the present invention, the glass transition temperature Tg of the nonmagnetic support ranges from 110° C. to 140° C. When the glass transition temperature Tg of the nonmagnetic support is lower than 110° C., the Young's modulus is low, increasing the tape width change rate. When the glass transition temperature Tg exceeds 140° C., breaks occur frequently during processing and productivity decreases. The glass transition temperature Tg of the nonmagnetic support is desirably 115 to 135° C., preferably 120 to 130° C. In the present invention, the term “glass transition temperature” is the temperature of the peak value of the loss tangent (tanδ) in dynamic viscoelasticity measurement at 1 Hz, and can be measured by the method indicated in Examples further below, for example.

Examples of nonmagnetic supports suitable for use are biaxially-drawn polyethylene naphthalate, polyethylene terephthalate, polyamide, polyimide, polyamideimide, aromatic polyamide, and polybenzoxidazole. Desirable examples are polyethylene naphthalate (PEN) and polymer alloy films with polyimides comprised chiefly of polyethylene terephthalate (PET) such as are described in Japanese. Unexamined Patent Publication (KOKAI) No. 2005-163020, which is expressly incorporated herein by reference in its entirety. The nonmagnetic support may be subjected in advance to corona discharge treatment, plasma treatment, adhesion-enhancing treatment, heat treatment, or the like. A metal reinforcement layer or the like may be provided on the surface of the nonmagnetic support.

The method of preparing the nonmagnetic support is not specifically limited, but the mechanical strength is desirably adjusted in the longitudinal and width directions. Specifically, when forming (manufacturing) a film of the above-described resin, a method of suitably drawing the resin in the longitudinal and width directions is desirably employed. The Young's modulus of the support employed in the present invention is preferably 4.4 to 15 GPa, more preferably 5.5 to 11 GPa, in both the longitudinal and width directions. The Young's modulus may differ in the longitudinal and width directions. An undrawn film can be biaxially drawn to impart a biaxial orientation to adjust the mechanical strength in the longitudinal and width directions. Successive biaxial drawing methods and simultaneous biaxial drawing methods may be employed as the drawing method. By way of preferable example, a successive biaxial drawing method by which drawing is first conducted in the longitudinal direction and then in the width direction can be employed. In the successive biaxial drawing method, the drawing in the longitudinal direction can be divided into three or more stages, the longitudinal drawing temperature can be 80 to 180° C., the total longitudinal drawing rate can be 3.0 to 6.0-fold, and the longitudinal drawing rate can range from 5,000 percent/minute to 50,000 percent/minute. A method employing a tenter is desirable as the drawing method in the width direction; the drawing temperature is desirably from the glass transition temperature (Tg) of the film to Tg+100° C., the drawing factor in the width direction is desirably 3.2 to 7.0-fold, sometimes larger than the drawing factor in the longitudinal direction, and the width direction drawing rate desirably ranges from 1,000 percent/min to 20,000 percent/min. Further, repeat longitudinal drawing and width drawing can be conducted as needed. Since drawing conditions such as the drawing factor and drawing temperature may greatly affect molecular orientation conditions, these conditions are desirably suitably selected to obtain a biaxially oriented film.

Next, the biaxially oriented film is desirably heated treated. The temperature of the heat treatment is suitably from the cold crystallization temperature (Tc)+40° C. to Tc+100° C., and the duration suitably falls within a range of 5 to 60 s. Since the glass transition temperature and amount of heat shrinkage may change based on these heat treatment conditions and based on the processing temperature conditions following the heat treatment in the course of returning to ordinary temperature, these conditions are desirably suitably selected to obtain a biaxially oriented film.

By subjecting the biaxially oriented film thus obtained to a heat treatment and suitably selecting the conditions employed in the heat treatment, it is possible to relax the enthalpy of the nonmagnetic support and obtain a magnetic recording medium of good electromagnetic characteristics and running durability. The heat treatment is not limited to just the support, but may be conducted at any stage, such as following formation of the magnetic layer. The temperature of the heat treatment can be set to 1 to 52° C. lower, preferably 15 to 52° C. lower, and more preferably, 20 to 45° C. lower than the glass transition temperature (Tg) of the material constituting the biaxially oriented film. When the temperature of the heat treatment is more than 52° C. lower than the glass transition temperature of the material constituting the support film, the duration of the heat treatment may become excessively long. Conversely, when the temperature of the heat treatment is higher than the glass transition temperature, main chain micro-Brownian motion may increase excessively, precluding enthalpy relaxation. To promote enthalpy relaxation, it is preferable to employ a high treatment temperature of close to the support Tg−1° C. However, when treatment is conducted at an excessively high temperature, the heat shrinkage rate of the web increases, causing increased web deformation failure, and the surface pressure on the core side increases when heat treatment is conducted with the stock material in a rolled up state on a core, compromising surface properties. Thus, the heat treatment is desirably conducted at a suitable temperature within a range that satisfies the conditions for achieving the required enthalpy relaxation.

The specific temperature of the above heat treatment will vary with the material constituting the support. The duration of the heat treatment is, for example, 1 hour to 14 days, desirably 5 hours to 7 days, and preferably, 10 hours to 50 hours. When the duration of the heat treatment is less than 1 hour, the effect of the heat treatment may not stably take hold. Although the effect is no different than for shorter periods, a heat treatment duration exceeding 14 days is undesirable in terms of productivity. Slow cooling to room temperature is desirable following the heat treatment.

The amount of heat absorption (referred to as the amount of enthalpy relaxation (ΔH), hereinafter) based on enthalpy relaxation due to the amorphous portions of the nonmagnetic support brought about by the above heat treatment can be set to equal to or greater than 0.5 J/g and equal to or less than 2.0 J/g. The enthalpy relaxation due to the amorphous portions occurs for reasons such as the following. The amorphous portion of polymeric substances constituting the nonmagnetic support and the like is in a liquid state at and above the glass transition temperature. When such substances are rapidly cooled from a liquid state, enthalpy is reduced while maintaining a state of equilibrium down to the glass transition temperature. Then, when the temperature of these substances drops lower than the glass transition temperature, the amorphous portion that was previously in a liquid state undergoes a phase transition, and its viscosity increases markedly. Thus, the mobility of segments such as the polymeric substances constituting the amorphous portion diminishes. As a result, the decrease in enthalpy of the amorphous portion does not track the drop in temperature accompanying cooling, and the amorphous portion changes in a nonequilibrium state, with excess enthalpy relative to an equilibrium state. In the substances with this excess enthalpy, the amorphous portion gradually changes from a nonequilibrium state to an equilibrium glass state, releasing the excess enthalpy. The above-described heat treatment can be conducted to promote the transition from a liquid state to an equilibrium glass state, rapidly achieving stabilization. Gradually raising the temperature of the substance in this state from lower than the glass transition temperature causes heat to be absorbed due to enthalpy relaxation in the amorphous portion at the glass transition temperature, with the amorphous portion of polymeric substances and the like undergoing a change in phase from an equilibrium glass state to a liquid state.

As is clear from the above description, in the enthalpy relaxation, there is a correlation between the amount of the reduction in enthalpy due to the amorphous portion changing from a nonequilibrium state to an equilibrium state, consequently, the extent of the above heat treatment: the greater the extent of the heat treatment, the greater the amount of enthalpy relaxation (ΔH). When the amount of enthalpy relaxation (ΔH) is less than 0.5 J/g, the degree of nonequilibrium in the glass state increases and the dimensional stability of the nonmagnetic support becomes inadequate for use in a magnetic recording medium. When the amount of enthalpy relaxation (ΔH) exceeds 2.0 J/g, there are problems such as a reduction in the degree of heightened orientation achieved by drawing. In the magnetic recording medium of the present invention, the above-described amount of heat absorption (ΔH) is equal to or greater than 0.5 J/g and equal to or less than 2.0 J/g, preferably equal to or greater than 0.6 J/g and equal to or less than 1.9 J/g, more preferably equal to or greater than 0.7 J/g and equal to or less than 1.8 J/g.

The center surface average roughness (JIS B 0660-1998, ISO 4287-1997) on the side of the nonmagnetic support on which the magnetic layer is coated is, for example, equal to or greater than 1.8 nm and equal to or less than 9 nm, desirably equal to or greater than 2 nm and equal to or less than 8 nm, with a cutoff value of 0.25 mm. The two surfaces of the support may be of different degrees of roughness. The thickness of the nonmagnetic support in the magnetic recording medium of the present invention is desirably equal to or greater than 3 micrometers and equal to or less than 10 micrometers.

### II. Magnetic Layer

<Number of indentations equal to or greater than 20 nm in depth present on the magnetic layer surface>

In the magnetic recording medium of the present invention, the number of indentations equal to or greater than 20 nm in depth present on the magnetic layer surface is equal to or less than 100/10,000 μm². When the number of indentations exceeds 100/10,000 μm², the dropout increases and good electromagnetic characteristics become difficult to achieve. The phenomenon may be particularly pronounced in the reproduction of a signal that has been recorded on the magnetic layer with a reproduction head of narrow track width, such as a reproduction head having a track width of equal to or less than 4 μm. The above-described number of indentations would ideally be zero, but in practice the lower limit may be about 2/10,000 μm². The above-described number of indentations is desirably 2 to 90/10,000 μm², preferably 2 to 70/10,000 μm². The above-described number of indentations refers to a value obtained by measuring the three-dimensional roughness of the magnetic layer with a Nanoscope III made by Digital Instruments of the U.S. and counting the number of indentations with a depth of equal to or greater than 20 nm from the average plane; see Examples, described further below, for details of the measurement method. In this context, the “average plane” is the plane for which the volume of indentations equals the volume of protrusions within the measurement plane. Methods of controlling the number of indentations are as set forth above, and the details will be described further below.

<Ferromagnetic metal powder (ferromagnetic metal micropowder)>

Ferromagnetic metal powder can be employed as the ferromagnetic powder. Ferromagnetic metal powder is known to afford good high-density magnetic recording characteristics. Ferromagnetic metal powder can be used to obtain a magnetic recording medium with good electromagnetic characteristics. The average axis length (“average major axis length” hereinafter) of the ferromagnetic metal powder employed in the magnetic layer of the magnetic recording medium of the present invention is, for example, equal to or greater than 20 nm and equal to or less than 60 nm, preferably equal to or greater than 25 nm and equal to or less than 50 nm, and more preferably, equal to or greater than 30 nm and equal to or less than 45 nm. Ferromagnetic metal powder with an average major axis length of equal to or greater than 20 nm can effectively suppress a drop in magnetic characteristics due to thermal fluctuation. An average major axis length of equal to or less than 60 nm makes it possible to achieve a good S/N ratio while maintaining low noise.

The average axial diameter (=average major axis length) of the ferromagnetic metal powder can be obtained by photographing the ferromagnetic metal powder by transmission electron microscopy and calculating the average of values obtained by combining the method of directly reading the minor axis diameter and major axis diameter of the ferromagnetic metal powder from the photographs with the method of reading by tracing the transmission electron microscope photographs with an IBASS I image analyzer made by Carl Zeiss.

The ferromagnetic metal powder employed in the magnetic layer is not specifically limited so long as it is comprised primarily of Fe, and preferably a ferromagnetic alloy power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Al and Y is particularly preferred. The Co content preferably ranges from 10 to 40 atom percent with respect to Fe. The Al content preferably ranges from 2 to 20 atom percent with respect to Fe. The content of Y preferably ranges from 1 to 15 atom percent with respect to Fe.

These ferromagnetic metal powders may be pretreated prior to dispersion with dispersing agents, lubricants, surfactants, antistatic agents, and the like, described further below. The ferromagnetic metal powder may contain a small quantity of moisture, hydroxide or oxide. The moisture content of the ferromagnetic metal powder is desirably 0.01 to 2 percent. The moisture content of the ferromagnetic metal powder is desirably optimized based on the type of binder. The pH of the ferromagnetic metal powder is desirably optimized depending on what is combined with the binder. A range of 6 to 12 can be established, with 7 to 11 being preferred. The ferromagnetic metal powder sometimes contains inorganic ions such as soluble Na, Ca, Fe, Ni, Sr, NH₄, SO₄, Cl, NO₂, NO₃ or the like. These are desirably substantially not present, but seldom affect characteristics at a total content of inorganic ions of equal to or less than 300 ppm. The ferromagnetic metal powder employed in the present invention desirably has few voids; the level is preferably equal to or less than 20 volume percent, more preferably equal to or less than 5 volume percent.

The crystallite size of the ferromagnetic metal powder is, for example, equal to or greater than 8 nm and equal to or less than 20 nm, preferably equal to or greater than 10 nm and equal to or less than 18 nm, and more preferably, equal to or greater than 12 nm and equal to or less than 16 nm. The crystallite size is an average value obtained by the method of Scherrer from the half-width of the diffraction peak under conditions of a radiation source of CuKαl, a tube voltage of 50 kV, and a tube current of 300 mA using an X-ray diffraction device (Rigaku RINT 2000 series).

The specific surface area by BET method of the ferromagnetic metal powder employed in the magnetic layer is preferably equal to or greater than 30 m²/g and less than 50 m²/g, more preferably 38 to 48 m²/g. Both good surface property and low noise can be achieved within the above range. As needed, the ferromagnetic metal powder can be surface treated with Al, Si, P, or an oxide thereof. The quantity can be set to 0.1 to 10 weight percent of the ferromagnetic metal powder. When applying a surface treatment, the quantity of a lubricant such as a fatty acid that is adsorbed is desirably not greater than 100 mg/m².

So long as the above-described particle size characteristics are satisfied, the ferromagnetic metal powder may be acicular, granular, or plate-shaped, with acicular ferromagnetic metal powder being preferred. The acicular ratio of the acicular ferromagnetic metal powder preferably ranges from 4 to 12, more preferably 5 to 12. The coercivity Hc of the ferromagnetic metal powder preferably ranges from 159.2 kA/m to 238.8 kA/m, more preferably 167.2 kA/m to 230.8 kA/m. The saturation magnetic flux density preferably ranges from 150 T·m to 300 T·m, more preferably 160 T·m to 290 T·m. The saturation magnetization as preferably ranges from 140 A·m²/kg to 170 A·m²/kg, more preferably 145 A·m²/kg to 160 A·m²/kg.

A ferromagnetic metal powder with a low switching field distribution (SFD) is desirable, with equal to or less than 0.8 being preferred. A SFD of equal to or less than 0.8 affords good electromagnetic characteristics, high output, sharp magnetic reversal, and little peak shift, which is suited to high-density digital magnetic recording. Methods of achieving a low Hc distribution include improving the particle size distribution of goethite in the ferromagnetic metal powder, employing monodisperse α-Fe₂O₃, and preventing sintering of particles, and the like.

The ferromagnetic metal powder that is employed may be obtained by known manufacturing methods, examples of which are: reducing iron oxide or water-containing iron oxide that has been treated to prevent sintering with a reducing gas such as hydrogen to obtain Fe or Fe-Co particles; reducing a compound organic acid salt (chiefly a salt of oxalic acid) with a reducing gas such as hydrogen; thermally decomposing a metal carbonyl compound; reduction by adding a reducing agent such as sodium boron hydride, hypophosphite, or hydrazine to the aqueous solution of a ferromagnetic metal; and evaporating a metal in an inert gas at low pressure to obtain micropowder. The ferromagnetic metal powder thus obtained is desirably subjected to a known slow oxidation treatment. The method of reducing iron oxide or water-containing iron oxide with a reducing gas such as hydrogen and controlling the time, temperature, and partial pressure of oxygen-containing gas and inert gas to form an oxide film on the surface is preferred due to low demagnetization.

<Ferromagnetic hexagonal ferrite powder>

Ferromagnetic hexagonal ferrite powder can be employed as the ferromagnetic powder. Ferromagnetic hexagonal ferrite powder has a hexagonal magnetoplumbite structure, extremely high single-axis crystal magnetic anisotropy, and extremely high coercivity (Hc). Thus, a magnetic recording medium in which ferromagnetic hexagonal ferrite powder is employed can exhibit good chemical stability, corrosion resistance, and abrasion resistance; permit a reduction in magnetic spacing at higher densities and the realization of thinner films; and afford a high C/N ratio and resolution. The average plate diameter of ferromagnetic hexagonal ferrite powder is preferably equal to or greater than 5 nm and equal to or less than 40 nm, more preferably equal to or greater than 10 nm and equal to or less than 38 nm, and further preferably, equal to or greater than 15 nm and equal to or less than 36 nm.

Generally, when the track density is increased and reproduction is conducted with a magnetoresistive head, it is necessary to keep the noise low and employ ferromagnetic hexagonal ferrite powder with a small average plate diameter. From the perspective of decreasing the magnetic spacing, it is desirable to employ hexagonal ferrite with as small a plate diameter as possible. However, when ferromagnetic hexagonal ferrite of excessively small average plate diameter is employed, magnetization is rendered unstable due to thermal fluctuation. Thus, the average plate diameter of the ferromagnetic hexagonal ferrite powder employed in the magnetic layer of the magnetic recording medium of the present invention is desirably equal to or greater than 5 nm. When the average plate diameter is equal to or greater than 5 nm, there is little effect due to thermal fluctuation and stable magnetization can be achieved. Additionally, the average plate diameter of the ferromagnetic hexagonal ferrite powder is desirably equal to or less than 40 nm. When the average plate diameter is equal to or less than 40 nm, it is possible to inhibit the drop in electromagnetic characteristics caused by increased noise, and reproduction with a magnetoresistive head (MR) is possible. The average plate diameter of ferromagnetic hexagonal ferrite powder can be obtained by photographing the ferromagnetic hexagonal powder by transmission electron microscopy and calculating the average of values obtained by measurement combining the method of directly reading the plate diameter of the ferromagnetic hexagonal ferrite powder from the photographs with the method of reading by tracing the transmission electron microscope photographs with an IBASS I image analyzer made by Carl Zeiss.

Examples of hexagonal ferrite ferromagnetic powders comprised in the magnetic layer are various substitution products of barium ferrite, strontium ferrite, lead ferrite, and calcium ferrite, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods.

The particle size of the ferromagnetic hexagonal ferrite powder is preferably 5 to 40 nm, more preferably 10 to 38 nm, further preferably 15 to 36 nm. The average plate thickness is preferably 1 to 30 nm, more preferably 2 to 25 nm, further preferably 3 to 20 nm. The plate ratio (plate diameter/plate thickness) is preferably 1 to 15, more preferably 1 to 7. When the plate ratio is within a range of 1 to 15, it is possible to achieve adequate orientation properties while maintaining a high filling property in the magnetic layer, as well as to prevent noise increase due to stacking between particles. In addition, the specific surface area by BET method within the above-mentioned particle size may be 10 to 200 m²/g, almost corresponding to an arithmetic value from the particle plate diameter and the plate thickness.

For the ferromagnetic hexagonal ferrite particle, narrow distributions of particle plate diameter and plate thickness are normally preferred. Although difficult to render in number form, 500 particles can be randomly measured in a TEM photograph of particles to make a comparison. The distributions of the particle plate diameter and plate thickness are often not a normal distribution. However, when expressed as the standard deviation to the average size, a/average size=0.1 to 2.0. The particle producing reaction system is rendered as uniform as possible and the particles produced are subjected to a distribution-enhancing treatment to achieve a sharp particle size distribution. For example, methods such as selectively dissolving ultrafine particles in an acid solution by dissolution are known.

The coercivity (Hc) of the hexagonal ferrite particle can be 159.2 to 238.8 kA/m, preferably 175.1 to 222.9 kA/m, more preferably 183.1 to 214.9 kA/m. However, when the saturation magnetization (σs) of the head exceeds 1.4 T, 159.2 kA/m or more is preferred. The coercivity (Hc) can be controlled by particle size (plate diameter and plate thickness), the types and quantities of elements contained, substitution sites of the element, the particle producing reaction conditions, and the like.

The saturation magnetization (σs) of the hexagonal ferrite particle is preferably 40 to 80 A·m²/kg. The higher saturation magnetization (σs) is preferred, however, it tends to decrease with decreasing particle size. Known methods of improving saturation magnetization (σs) are combining spinel ferrite with magnetoplumbite ferrite, selection of the type and quantity of elements incorporated, and the like. It is also possible to employ W-type hexagonal ferrite. When dispersing the magnetic material, the surface of the magnetic material particles can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added ranges from, for example, 0.1 to 10 weight percent relative to the weight of the magnetic material. The pH of the magnetic material is also important to dispersion. A pH of about 4 to 12 is usually optimum for the dispersion medium and polymer. From the perspective of the chemical stability and storage properties of the medium, a pH of about 6 to 11 can be selected. Moisture contained in the magnetic material also affects dispersion. There is an optimum level for the dispersion medium and polymer, usually selected from the range of 0.01 to 2.0 percent.

Methods of manufacturing the ferromagnetic hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to 100° C. or greater; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. However, any manufacturing method can be selected in the present invention. The ferromagnetic hexagonal ferrite powder may be surface treated as necessary with Al, Si, P, an oxide thereof, or the like. The quantity employed desirably ranges from 0.1 to 10 percent of the ferromagnetic powder, and when a surface treatment is conducted, a lubricant such as a fatty acid is desirably adsorbed in a quantity of equal to or less than 100 mg/m². An inorganic ion in the form of soluble Na, Ca, Fe, Ni, Sr, or the like may be contained in the ferromagnetic powder. These are preferably substantially not contained, but at levels of equal to or less than 200 ppm, characteristics are seldom affected.

### III. Nonmagnetic Powder

The magnetic recording medium of the present invention can comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder desirably ranges from 4 nm to 1 micrometer, preferably from 40 to 100 nm. A crystallite size falling within a range of 4 nm to 1 micrometer is desirable in that it facilitates dispersion and imparts a suitable surface roughness. The average particle diameter of the nonmagnetic powder desirably ranges from 5 nm to 2 micrometers. As needed, nonmagnetic powders of differing average particle diameter may be combined; the same effect may be achieved by broadening the average particle distribution of a single nonmagnetic powder. The preferred average particle diameter of the nonmagnetic powder ranges from 10 to 200 nm. Within a range of 5 nm to 2 micrometers, dispersion is good and good surface roughness is achieved.

The specific surface area of the nonmagnetic powder desirably ranges from 1 to 100 m²/g, preferably from 5 to 70 m²/g, and more preferably from 10 to 65 m²/g. Within the specific surface area ranging from 1 to 100 m²/g, suitable surface roughness is achieved and dispersion is possible with the desired quantity of binder. Oil absorption capacity using dibutyl phthalate (DBP) desirably ranges from 5 to 100 mL/100 g, preferably from 10 to 80 mL/100 g, and more preferably from 20 to 60 mL/100 g. The specific gravity desirably ranges from 1 to 12, preferably from 3 to 6. The tap density desirably ranges from 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder desirably ranges from 2 to 11, preferably from 6 to 9. When the pH falls within a range of 2 to 11, the coefficient of friction may not become high at high temperature or high humidity or due to the freeing of fatty acids. The moisture content of the nonmagnetic powder desirably ranges from 0.1 to 5 weight percent, preferably from 0.2 to 3 weight percent, and more preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 micromol/m², more preferably from 2 to 15 micromol/m². The heat of wetting in 25° C. water of the nonmagnetic powder is preferably within a range of 200 to 600 erg/cm². A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders is preferably treated with Al₂O₃, SiO₂, TiO₂, ZrO₂, SnO₂, Sb₂O₃, and ZnO. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders suitable for use in the nonmagnetic layer in the present invention are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, MT-600B, MT-100F and MT-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed.

### IV. Binder

Conventionally known thermoplastic resins, thermosetting resins, reactive resins and mixtures thereof may be employed as binders employed in the magnetic layer and nonmagnetic layer in the present invention. Examples of the thermoplastic resins are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins.

Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. The thermoplastic resins, the thermosetting resins and the reactive resins are described in detail in the Handbook of Plastics published by Asakura Shoten, which is expressly incorporated herein by reference in its entirety.

Further, when an electron beam-curable resin is employed in the magnetic layer, not only coating strength can be improved to improve durability, but also the surface is rendered smooth to enhance electromagnetic characteristics.

The above-described resins may be employed singly or in combination. Of these, the use of polyurethane resin is preferred. In particular, the use of the following polyurethane resin is further preferred; a polyurethane resin prepared by reacting a cyclic compound such as hydrogenated bisphenol A or a polypropylene oxide adduct of hydrogenated bisphenol A, a polyol with a molecular weight of 500 to 5,000 comprising an alkylene oxide chain, a chain-extending agent in the form of a polyol with a molecular weight of 200 to 500 having a cyclic structure, and an organic diisocyanate, as well as introducing a hydrophilic polar group; a polyurethane resin prepared by reacting an aliphatic dibasic acid such as succinic acid, adipic acid, or sebacic acid, a polyester polyol comprised of an aliphatic diol not having a cyclic structure having an alkyl branching side chain such as 2,2-dimethyl-1,3-propanediol, 2-ethyl-2-butyl-1,3-propanediol, 2,2-diethyl-1,3-propanediol, a chain-extending agent such as an aliphatic diol having a branching alkyl side chain with three or more carbon atoms, such as 2-ethyl-2-butyl-1,3-propanediol, 2,2-diethyl-1,3-propanediol, and an organic diisocyanate, as well as introducing a hydrophilic polar group; and a polyurethane resin prepared by reacting a cyclic structure such as a dimer diol, a polyol compound having a long alkyl chain, and an organic diisocyanate, as well as introducing a hydrophilic polar group.

The average molecular weight of the polyurethane resin comprising a polar group that is employed in the present invention desirably ranges from 5,000 to 100,000, preferably from 10,000 to 50,000. An average molecular weight of equal to or greater than 5,000 is desirable in that it yields a magnetic coating that does not undergo a decrease in physical strength, such as by becoming brittle, and that does not affect the durability of the magnetic recording medium. A molecular weight of equal to or less than 100,000 may not reduce solubility in solvent and thus afford good dispersion. Further, since the coating material viscosity may not become high at defined concentrations, manufacturing properties can be good and handling can be facilitated.

Examples of the polar group comprised in the above-described polyurethane resins are: —COOM, —SO₃M, —OSO₃M, —P═O(OM)₂, —O—P═O(OM)₂ (where M denotes a hydrogen atom or alkali metal base), —OH, —NR₂, —N⁺R₃ (where R denotes a hydrocarbon group), epoxy group, —SH, and —CN. At least one of these polar groups may be incorporated by copolymerization or an addition reaction for use. When the polar group-comprising polyurethane resin contains an OH group, a branched OH group is desirable from the perspectives of curing properties and durability. The branched OH group number of 2 to 40 is desirably per molecule, with the presence of 3 to 20 per molecule being preferred. The quantity of such polar groups ranges from, for example, 10⁻¹ to 10⁻⁸ mol/g, preferably from 10⁻² to 10⁻⁶ mol/g.

Specific examples of binders are VAGH, VYHH, VMCH, VAGF, VAGD, VROH, VYES, VYNC, VMCC, XYHL, XYSG; PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000 W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The quantity of binder employed in the magnetic layer desirably falls within a range of, for example, 5 to 50 weight percent, preferably within a range of 10 to 30 weight percent, of the ferromagnetic powder (ferromagnetic magnetic powder or ferromagnetic hexagonal ferrite powder). In the case of a polyurethane resin, it is desirably employed in a quantity of 2 to 20 weight percent, and in the case of polyisocyanate, it is desirably employed in a quantity of 2 to 20 weight percent. It is desirable to employ them together. However, for example, when head corrosion occurs due to the release of trace amount of chlorine, it is possible to employ just polyurethane or polyurethane and isocyanate. When another resin in the form of vinyl chloride resin is employed, the desirable range is 5 to 30 weight percent. When employing polyurethane in the present invention, the glass transition temperature preferably ranges from −50 to 150° C., more preferably from 0 to 100° C. The elongation at break desirably ranges from 100 to 2,000 percent, the stress at break from 0.49 to 98 MPa, and the yield point from 0.49 to 98 MPa.

The magnetic recording medium preferably comprises a nonmagnetic layer and at least one magnetic layer. Accordingly, the quantity of binder; the proportion of vinyl chloride resin, polyurethane resin, polyisocyanate, or some other resin in the binder; the molecular weight and quantity of polar groups in the various resins in the magnetic layer; and the physical characteristics of the above-described resins may be varied as needed from the nonmagnetic layer to the individual magnetic layers. They should be optimized for each layer. Known techniques for a multilayered magnetic layer may be applied. For example, when varying the quantity of binder in each layer, the quantity of binder in the magnetic layer may be increased to effectively reduce rubbing damage to the magnetic layer surface, and the quantity of binder in the nonmagnetic layer may be increased to impart flexibility for good head touch.

Examples of polyisocyanates suitable for use in the present invention are tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co. Ltd.; and Desmodule L, Desmodule IL, Desmodule N and Desmodule HL manufactured by Sumitomo Bayer Co. Ltd. They can be used singly or in combinations of two or more in each of layers by exploiting differences in curing reactivity.

### V. Other Additives

Additives may be added to the magnetic layer and nonmagnetic layer as needed. Examples of such additives are: abrasives, lubricants, dispersing agents, antifungal agents, antistatic agents, oxidation inhibitors, solvents, and carbon black.

Examples are molybdenum disulfide; tungsten disulfide; graphite; boron nitride; graphite fluoride; silicone oils; silicones having a polar group; fatty acid-modified silicones; fluorine-containing silicones; fluorine-containing alcohols; fluorine-containing esters; polyolefins; polyglycols; polyphenyl ethers; aromatic ring-containing organic phosphorous acids such as phenylphosphorous acid and their alkali metal salts; alkylphosphorous acids such as octylphosphorous acid and their alkali metal salt; aromatic phosphoric acid esters such as phenylphosphate and their alkali metal salts; alkylphosphoric acid esters such as octylphosphate and their alkali metal salt; alkylsulfonic acid esters and their alkali metal salts; fluorine-containing alkylsulfuric acid esters and their alkali metal salts; monobasic fatty acids with 10 to 24 carbon atoms (which may contain an unsaturated bond or be branched) such as lauric acid and their alkali metal salts; monofatty esters, difatty esters, or polyfatty esters such as butyl stearate comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched); alkoxy alcohols having 12 to 22 carbon atoms (which may contain an unsaturated bond or be branched) and monoalkyl ethers of alkylene oxide polymers; fatty acid amides comprising 2 to 22 carbon atoms, and fatty acid amines comprising 8 to 22 carbon atoms. Compounds comprising alkyl groups, aryl groups, and aralkyl groups substituted with groups other than the above-mentioned hydrocarbon groups such as nitro groups or hydrocarbon groups containing halogens such as F, Cl, Br, CF₃, CCl₃, and CBr₃ may also be employed. Further, nonionic surfactants such as alkylene oxid-based one, glycerine-based one, glycidol-based one and alkyl phenol ethylene oxide adducts; cationic surfactants such as cyclic amines, ester amides, quaternary ammonium salts, hydantoin derivatives, heterocycles, phosphoniums, and sulfoniums; anionic surfactants such as carboxylic acids, sulfonic acids, sulfuric esters, and other acid group-comprising compounds; and amphoteric surfactants such as amino acids, aminosulfonic acids, sulfuric and phosphoric acid esters of aminoalcohols, and alkyl betaines may also be employed.

These surfactants are described in detail in, “A Handbook of Surfactants” (published by Sangyo Tosho K.K.), which is expressly incorporated herein by reference in its entirety. These additives need not necessarily be pure, and may comprise isomers, unreacted products, side-products, decomposition products, oxides, and other impurities in addition to the principal components. The impurities desirably constitute equal to or less than 30 weight percent, preferably equal to or less than 10 weight percent. Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co., Ltd.; NJLUB OL manufactured by New Japan Chemical Co. Ltd.; TA-3 manufactured by Shin-Etsu Chemical Co. Ltd.; Armide P manufactured by Lion Armour Co., Ltd.; Duomine TDO manufactured by Lion Corporation; BA-41G manufactured by Nisshin Oil Mills, Ltd.; and Profan 2012E, Newpole PE61 and Ionet MS-400 manufactured by Sanyo Chemical Industries, Ltd.

Carbon black may be admixed to the magnetic layer and nonmagnetic layer to decrease surface resistivity and achieve the desired micro Vicker's hardness. The micro Vicker's hardness normally ranges from 25 to 60 kg/mm², and preferably from 30 to 50 kg/mm² to adjust head touch. It can be measured with a thin-film hardness meter (the HMA-400 manufactured by NEC Corporation) using a triangular diamond indenter tip with a front end radius of 0.1 micrometer and an edge angle of 80 degrees. Examples of carbon blacks suitable for use in the magnetic layer and the nonmagnetic layer are furnace black for rubber, thermal for rubber, black for coloring, and acetylene black.

As for the carbon black, the specific surface area desirably ranges from 5 to 500 m²/g, the DBP oil absorption capacity from 10 to 400 mL/100 g, the particle diameter from 5 to 300 nm, the pH from 2 to 10, the moisture content from 0.1 to 10 percent, and the tap density from 0.1 to 1 g/mL. Specific examples of types of carbon black suitable for use in the nonmagnetic layer are: BLACK PEARLS 2000, 1300, 1000, 900, 905, 800, 700 and VULCAN XC-72 from Cabot Corporation; #80, #60, #55, #50 and #35 from Asahi Carbon Co., Ltd.; #3050B, #3150B, #3250B, #3750B, #3950B, #2400B, #2300, #1000, #970B, #950, #900, #850B, #650B, #30, #40, #10B and MA-600 from Mitsubishi Chemical Corporation; CONDUCTEX SC, RAVEN 8800, 8000, 7000, 5750, 5250, 3500, 2100, 2000, 1800, 1500, 1255, 1250, 150, 50, 40, 15 and RAVEN-MT-P from Columbia Carbon Co., Ltd.; and Ketjen Black EC from Lion Akzo Co., Ltd.

The carbon black employed can be surface treated with a dispersing agent or the like, grafted with a resin, or a portion of the surface may be graphite-treated. Further, the carbon black may be dispersed with a binder prior to being added to the magnetic or nonmagnetic coating material. These types of carbon black may be employed singly or in combination. When employing carbon black, the quantity preferably ranges from 0.1 to 30 weight percent with respect to the weight of the magnetic material. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. The Carbon Black Handbook compiled by the Carbon Black Association, which is expressly incorporated herein by reference in its entirety, may be consulted for types of carbon black suitable for use in the magnetic layer.

In the present invention, known organic solvent can be employed. The organic solvent employed in the present invention may be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane. These organic solvents need not be 100 percent pure and may contain impurities such as isomers, unreacted materials, by-products, decomposition products, oxides and moisture in addition to the main components. The content of these impurities is preferably equal to or less than 30 percent, more preferably equal to or less than 10 percent. Preferably the same type of organic solvent is employed in the present invention in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the upper layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

The types and quantities of dispersing agents, lubricants, and surfactants employed in the magnetic layer may differ from those employed in the nonmagnetic layer. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like. Accordingly, the surface of a ferromagnetic powder (ferromagnetic metal powder and ferromagnetic hexagonal ferrite powder) or the surface of a nonmagnetic powder becomes covered with the alkyl group, aromatic groups, and the like. This enhances the compatibility of the ferromagnetic powder or nonmagnetic powder with the binder resin component, further improving the dispersion stability of the ferromagnetic powder or nonmagnetic powder. Further, lubricants are normally present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### VI. Backcoat Layer and Adhesion-Enhancing Layer

Generally, greater repeat running properties are demanded of magnetic tapes employed in computer data recording than of audio and video tapes. To maintain such high running durability, a backcoat layer is provided on the opposite side of the nonmagnetic support from the side on which the magnetic layer are provided in the magnetic recording medium of the present invention. According to the present invention as set fort above, even when the heat treatment is conducted in a state where the magnetic layer surface contacts with the backcoat layer surface, indentations on the magnetic layer surface can be reduced, yielding good electromagnetic characteristics.

The backcoat layer coating liquid can be prepared by dispersing the binder and granular components such as abrasives and antistatic agents in an organic solvent. Various inorganic pigments and carbon black may be employed as granular components. Nitrocellulose, phenoxy resin, vinyl chloride resin, polyurethane, and other resins may be employed singly or in combination as the binder. The formula of the backcoat layer coating liquid can be adjusted to effectively reduce indentations on the magnetic layer surface. Details thereof are as set forth below.

An adhesion-enhancing layer can be provided on the surface of the nonmagnetic support to enhance the adhesion. For example, the following solvent-soluble compounds may be employed to the adhesion-enhancing layer: polyester resin, polyamide resin, polyamidoimide resin, polyurethane resin, vinyl chloride resin, vinylidene chloride resin, phenol resin, epoxy resin, urea resin, melamine resin, formaldehyde resin, silicone resin, starch, modified starch compounds, alginic acid compounds, casein, gelatin, pullulan, dextran, chitin, chitosan, rubber latex, gum Arabic, funori, natural gum, dextrin, modified cellulose resin, polyvinyl alcohol resin, polyethylene oxide, polyacrylic acid-based resin, polyvinyl pyrrolidone, polyethyleneimine, polyvinyl ether, polymaleic acid copolymers, polyacrylamide, and alkyd resins.

The adhesion-enhancing layer desirably ranges from 0.01 to 3.0 micrometers, preferably from 0.02 to 2.0 micrometers, more preferably 0.05 to 1.5 micrometers in thickness. The glass transition temperature of the resin employed in the adhesion-enhancing layer is desirably from 30 to 120° C., preferably from 40 to 80° C. At equal to or greater than 30° C., blocking may not occur on the two end surfaces, and at equal to or less than 120° C., internal stress in the adhesive-enhancing layer can be alleviated and good adhesive strength achieved.

### VII. Layer Structure

In the magnetic recording medium of the present invention, at least two coating layers, that is, a magnetic layer and a nonmagnetic layer is preferably provided on at least one surface of a nonmagnetic support. The magnetic layer may be comprised of two or more layers when necessary. A backcoat layer is provided on the opposite surface of the nonmagnetic support. Further, various coatings such as lubricant coatings and magnetic layer protecting coatings may be provided as needed on the magnetic layer. An undercoating layer (adhesion-enhancing layer) may be provided between the nonmagnetic support and the nonmagnetic layer in order to increase adhesion between the coating layer and the nonmagnetic support.

In the magnetic recording medium of the present invention, it is preferable for the nonmagnetic layer and magnetic layer to be present on one surface of the nonmagnetic support. When coating the nonmagnetic layer (lower layer) and magnetic layer (upper layer), the lower layer can be coated first, and the upper layer (magnetic layer) provided while the lower layer is still wet or once it has dried.

The thickness of the nonmagnetic support desirably ranges from 3 to 80 micrometers. In computer tapes, a nonmagnetic support having a thickness of 3.5 to 7.5 micrometers, preferably from 3 to 7 micrometers, can be employed. Further, when providing an undercoating layer between the nonmagnetic support and the nonmagnetic layer, the thickness of the undercoating layer is desirably from 0.01 to 0.8 micrometer, preferably from 0.02 to 0.6 micrometer. Further, as for the backcoat layer provided on the opposite side from the side on which the magnetic layer is provided on the nonmagnetic support, the thickness thereof is, for example, from 0.1 to 1.0 micrometer, preferably from 0.2 to 0.8 micrometer.

The thickness of the magnetic layer is optimized based on the saturation magnetization level and head gap length of the magnetic head employed and the recording signal band, but is generally from 10 to 100 nm, preferably from 20 to 80 nm, and more preferably from 30 to 80 nm. Further, the thickness fluctuation rate of the magnetic layer is desirably within ±50 percent, preferably within ±40 percent. The magnetic layer comprises at least one layer, but may be separated into two or more layers having different magnetic characteristics. Known multilayer magnetic layer configurations may be employed.

The thickness of the nonmagnetic layer is, for example, 0.02 to 3.0 micrometers, preferably from 0.05 to 2.5 micro-meters, and more preferably, from 0.1 to 2.0 micrometers. When the magnetic recording medium of the present invention has a nonmagnetic layer, the nonmagnetic layer can effectively function so long as it is essentially nonmagnetic. For example, even when an impurity or an intentional trace amount of magnetic material is contained, the effect of the present invention is exhibited and the configuration can be seen as being essentially identical to that of the magnetic recording medium of the present invention. The term “essentially identical” means that the residual magnetic flux density of the nonmagnetic layer is equal to or less than 10 T·m (100 G) or the coercive force is equal to or less than 7.96 kA/m (100 Oe), with the absence of a residual magnetic flux density and coercive force being preferred.

### VIII. Physical Properties

The saturation magnetic flux density of the magnetic layer is desirably from 100 to 300 T·m. The coercivity (Hc) of the magnetic layer is desirably from 143.3 to 318.4 kA/m, preferably from 159.2 to 278.6 kA/m. The coercivity distribution is desirably narrow, with the SFD and SFDr being equal to or less than 0.6, preferably equal to or less than 0.2.

The coefficient of friction of the magnetic recording medium of the present invention with the head is desirably equal to or less than 0.5, preferably equal to or less than 0.3, over a temperature range of −10 to 40° C. and a humidity range of 0 to 95 percent. Specific surface resistivity is from 10⁴ to 10¹² Ω/sq on the magnetic surface, and the charge potential is desirably within a range of −500 to +500 V. The modulus of elasticity at 0.5 percent elongation of the magnetic layer is desirable from 0.98 to 19.6 GPa in all in-plane directions. The breaking strength is desirably from 98 to 686 MPa. The modulus of elasticity of the magnetic recording medium is desirably from 0.98 to 14.7 GPa in all in-plane directions.

The heat shrinkage rate of the magnetic recording medium of the present invention is desirably equal to or less than 0.20 percent, preferably equal to or less than 0.15 percent. The “heat shrinkage rate” refers to the heat shrinkage rate during 48 hours of storage at 70° C., and can be measured by the method indicated in Examples described further below. The heat shrinkage rate is the residual distortion of the magnetic recording medium. When the heat shrinkage rate is high, the stress distribution in the radial direction increases when a long medium is wound on a core and stored, and the change in the width dimension ends up increasing. The heat shrinkage rate would ideally be 0, but in practice, the lower limit may be about 0.02 percent.

The heat shrinkage rate can be decreased by subjecting the magnetic recording medium to a heat treatment. The heat treatment used to promote curing of the magnetic layer that is conducted on a magnetic recording medium wound up into a roll, described further below, also has the effect of reducing the heat shrinkage rate.

The sol component ratio in the magnetic layer is equal to or less than 5.0 percent, preferably equal to or less than 3.0 percent. The “sol component ratio” is a value relative to the weight of the magnetic layer, and correlates to the amount of unreacted component contained in the magnetic layer. A high sol component ratio means that curing is inadequate. When an inadequately cured magnetic layer is repeatedly run across a head, marked accumulation of head grime occurs. The sol component ratio is ideally 0, but in practice, the lower limit may be about 0.5 percent. In the present invention, the term “sol component ratio” is a value measured by the following method.

The sol component ratio can be reduced by subjecting a magnetic recording medium wound up into a roll to a heat treatment, described further below.

(Method of Measuring the Sol Component Ratio) A 0.5 g quantity of magnetic layer sample from the magnetic layer formed on the nonmagnetic support for use in measuring the sol component ratio is weighed out and immersed for 30 minutes in 50 mL of hexane to remove the lubricant. The hexane is then removed and the sample is immersed for 1 hour in 80 mL of THF to dissolve out the binder sol component. The THF and the binder solution that has been dissolved out are evaporated. The lubricant is then extracted again with hexane and the sample is dried in a vacuum drier. The sol component is weighed and the sol component ratio is calculated. When the magnetic layer is comprised of multiple layers, the value obtained by weighing the entire magnetic layer is adopted as the sol component ratio.

The magnetic recording medium of the present invention may be in the form of a disk or a tape. When the magnetic recording medium is a tape-shaped medium, the tape width change rate is desirably equal to or less than 800 ppm. Keeping the amount of enthalpy relaxation in the nonmagnetic support to within the above-stated range can yield a magnetic tape with a tape width change rate of equal to or less than 800 ppm. A tape width change rate of equal to or less than 800 ppm is desirable because dimensional stability in the operating environment and storage environment is high. The tape width change rate is desirably 240 to 780 ppm, preferably 240 to 760 ppm. In the present invention, the term “tape width change rate ” refers to a value obtained by adding the “amount of change in tape width in an operating environment” and the “amount of change in tape width following storage” measured by the methods described further below in Examples.

The glass transition temperature of the magnetic layer (the peak loss elastic modulus of dynamic viscoelasticity measured at 110 Hz) is desirably from 50 to 180° C., and that of the nonmagnetic layer is desirably from 0 to 180° C. The loss elastic modulus desirably falls within a range of 1×10⁷ to 8×10⁸ Pa and the loss tangent is desirably equal to or less than 0.2. Excessive high loss tangent tends to cause a adhesion failure. These thermal and mechanical characteristics are desirably identical to within 10 percent in all in-plane directions of the medium.

The residual solvent contained in the magnetic layer is desirably equal to or less than 100 mg/m², preferably equal to or less than 10 mg/m². The void rate of the coated layer is desirably equal to or less than 30 volume percent, preferably equal to or less than 20 volume percent, in both the nonmagnetic and magnetic layers. A low void rate is desirable to achieve high output, but there are objectives for which ensuring a certain value is good. For example, in disk media in which repeat applications are important, a high void rate is often desirable for running durability.

The maximum height SRₘₐₓ of the magnetic layer is desirably equal to or less than 0.5 micrometer. The ten-point average roughness SRz is desirably equal to or less than 0.3 micrometer. The center surface peak SRp is desirably equal to or less than 0.3 micrometer. The center surface valley depth SRv is desirably equal to or less than 0.3 micrometer. The center surface surface area SSr is desirably from 20 to 80 percent. And the average wavelength Sλa is desirably from 5 to 300 micrometers. These can be readily controlled by controlling the surface properties by means of fillers employed in the support and the surface shape of the rolls employed in calendering. Curling is desirably within ±3 mm.

It is possible to vary the physical characteristics between the nonmagnetic layer and the magnetic layer based on the objective. For example, while increasing the modulus of elasticity of the magnetic layer to improve running durability, it is possible to make the modulus of elasticity of the nonmagnetic layer lower than that of the magnetic layer to enhance contact between the magnetic recording medium and the head.

### IX. Manufacturing Method

The process of manufacturing the magnetic layer coating liquid and nonmagnetic layer coating liquid comprises at least a kneading step, dispersion step, and mixing steps provided as needed before and after these steps. Each of the steps may be divided into two or more stages. All of the starting materials employed in the present invention, including the ferromagnetic hexagonal ferrite powder or ferromagnetic metal powder, nonmagnetic powder, binder, carbon black, abrasives, antistatic agents, lubricants, and solvents may be added at the beginning or during any step. Further, each of the starting materials may be divided and added during two or more steps. For example, polyurethane may be divided up and added during the kneading step, dispersion step, and mixing step for viscosity adjustment following dispersion. To achieve the object of the present invention, conventionally known manufacturing techniques may be employed for some of the steps. A kneading device of high kneading strength such as an open kneader, continuous kneader, pressure kneader, or extruder is desirably employed in the kneading step. When a kneader is employed, all or a portion (with equal to or greater than 30 percent of the total binder being desirable) of the magnetic powder or nonmagnetic powder and binder can be kneaded in a proportion of 15 to 500 weight parts by weight per 100 weight parts by weight of magnetic material. The details of the kneading process are described in detail in Japanese Unexamined Patent Publication (KOKAI) Heisei Nos. 1-106338 and 1-79274. The contents of these applications are expressly incorporated herein by reference in their entirety. Further, glass beads may be employed to disperse the magnetic layer coating liquid and nonmagnetic coating liquid. A dispersion medium having a high specific gravity such as zirconia beads, titania beads, or steel beads is suitable for use as the glass beads. The particles diameter and fill rate of the dispersion medium are optimized for use. A known dispersing machine may be employed.

In the method of manufacturing the magnetic recording medium of the present invention, the magnetic layer coating liquid can be coated to a prescribed film thickness on the surface of the nonmagnetic support while running to form a magnetic layer. In this process, multiple magnetic layer coating liquids can be sequentially or simultaneously multilayer coated, and the nonmagnetic layer coating liquid and magnetic layer coating liquid can be sequentially or simultaneously multilayer coated. Coating machines suitable for use in coating the magnetic and nonmagnetic coating materials mentioned above are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K. may be referred to in this regard, which is expressly incorporated herein by reference in its entirety.

In the case of a magnetic tape, the layer formed by coating the magnetic layer coating liquid can be magnetically oriented in the longitudinal direction using a cobalt magnet or solenoid on the ferromagnetic powder contained in the layer formed by coating the magnetic layer coating liquid. In the case of a disk, although isotropic orientation can be adequately achieved without orientation using an orientation device, the positioning of cobalt magnets at mutually oblique angles or the use of a known random orientation device such as the application of an alternating current magnetic field with solenoids is desirably employed. In the case of ferromagnetic metal powder, the term “isotropic orientation” generally desirably means two-dimensional in-plane randomness, but can also mean three-dimensional randomness when a vertical component is imparted. In the case of hexagonal ferrite, three-dimensional randomness in the in-plane and vertical directions is generally readily achieved, but two-dimensional in-plane randomness is also possible. A known method such as magnets with opposite poles opposed may be employed to impart isotropic magnetic characteristics in a circumferential direction using a vertical orientation. Vertical orientation is particularly desirable in the case of high-density recording. Further, spin coating may be employed to achieve circumferential orientation.

The temperature and flow rate of drying air and the coating rate are desirably determined to control the drying position of the coated film. The coating rate is desirably from 20 m/min to 1,000 m/min and the temperature of the drying air is desirably equal to or greater than 60° C. It is also possible to conduct suitable predrying before entry into the magnet zone. The tension applied on the longitudinal direction of the web conveyed in a drying process is preferably 1MPa to 50 MPa.

Following drying, a surface smoothing treatment can be applied to the coating layer. For example, supercalender rolls can be employed in the surface smoothing treatment. The surface smoothing treatment can eliminate holes produced by the removal of solvent during drying and improve the fill rate of ferromagnetic powder in the magnetic layer, making it possible to obtain a magnetic recording medium of high electromagnetic characteristics. Heat-resistant plastic rolls such as epoxy, polyimide, polyamide, and polyamidoimide rolls may be employed as the calendering rolls. Processing with metal rolls is also possible. The magnetic recording medium of the present invention desirably has an extremely smooth surface. For example, this is achieved by subjecting a magnetic layer formed by selecting a ferromagnetic powder and binder such as have been set forth above to the above-described calendering. Calendering is desirably conducted under conditions of a calendering roll temperature falling within a range of 60 to 100° C., preferably within a range of 70 to 100° C., and more preferably within a range of 80 to 100° C., at a pressure falling within a range of 98 to 490 kN/m, preferably within a range of 196 to 441 kN/m, and more preferably within a range of 294 to 392 kN/m.

Means of reducing the above-described heat shrinkage rate include the method of heat treatment in the form of a web while handling with low tension and the method of heat treating (the thermotreatment method) a bulk tape or a tape that has been loaded into a cassette in a stacked mode; both methods can be employed. From the perspectives of providing a magnetic recording medium of high output and low noise, the thermotreatment method is desirable. The thermotreatment method is effective for promoting curing of the magnetic layer and reducing the sol component ratio. Since protrusions in the backcoat layer are transferred to the magnetic layer, producing indentations in the magnetic layer that cause deterioration of electromagnetic characteristics, when the thermotreatment is conducted, measures for preventing the generation of indentations by adjusting the formula of the backcoat layer as set forth above are desirably devised or, as set forth further below, it is desirable to conduct a treatment to reduce the indentations in post-processing.

The magnetic recording medium obtained can be cut to desired size with a cutter or the like for use.

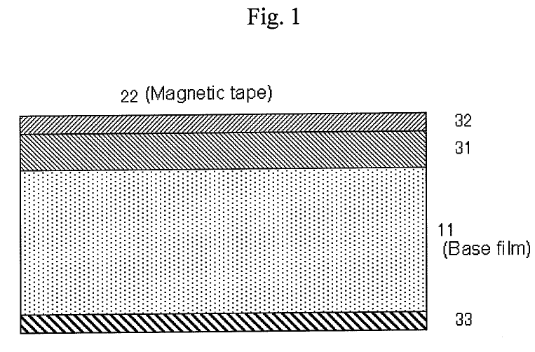

FIG. 1 shows a schematic sectional view of magnetic tape 22, an example of the magnetic recording medium of the present invention. On one side of nonmagnetic support 11 are formed nonmagnetic layer 31 and magnetic layer 32. On the opposite side of film 11 from the side on which are formed layers 31 and 32 is formed backcoat layer 33.

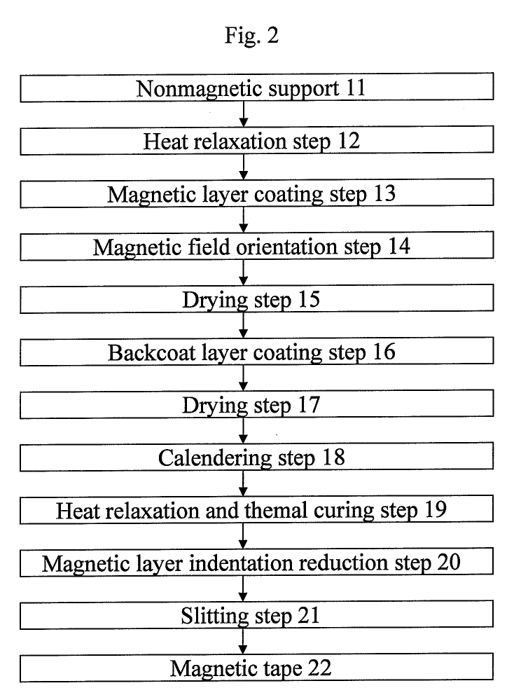

FIG. 2 shows manufacturing process 10 descriptive of the method of manufacturing a magnetic recording medium of the present invention. However, the method of manufacturing a magnetic recording medium of the present invention is not limited to the embodiments described below.

A nonmagnetic support in the form of a film (“film” hereinafter) having a glass transition temperature ranging from 110° C. to 140° C. is employed. Step 12 of subjecting the nonmagnetic support to a heat treatment to relax the heat can be provided first. This heat relaxation process relaxes the excess enthalpy in the nonmagnetic support. The heat treatment is desirably conducted at not more than 52° C. lower but not less than 1° C. lower than the heat transition temperature of the support for from 1 hour or more to 14 days or less. As set forth above, the temperature can be more than 52° C. lower than the glass transition temperature of the support, but this is undesirable because the duration of the treatment may be excessively long and productivity may decrease. Additionally, when the temperature of the heat treatment is higher than the glass transition temperature, the main chain micro-Brownian motion of the polymeric material in the support becomes excessive, precluding enthalpy relaxation. In the course of cooling following the heat treatment, slow cooling is desirably conducted at a rate of about 2° C./hour. To maintain the level of enthalpy relaxation achieved by relaxing excess enthalpy by means of the heat treatment, processing should be conducted by setting the temperature of the nonmagnetic support in postprocessing so that it does not rise above the glass transition temperature of the support. Heat relaxation and thermal curing step 19 is also desirably conducted among the steps conducted after heat relaxation step 12. When heat relaxation and thermal curing step 19 is omitted, thermal curing of the binder employed in the magnetic layer may not progress adequately, making it difficult to ensure durability and achieve a reduction in head grime. When productivity is considered, manufacturing is desirably conducted in the processing order stated in manufacturing process 10 by omitting step 12, with the relaxation of excess enthalpy of step 12 being conducted in heat relaxation and thermal curing step 19 to reduce the number of steps and ensure high productivity.

The various coating liquids are coated in coating step 15 to sequentially form the above-described nonmagnetic layer and magnetic layer on film 11. In coating step 15, the nonmagnetic layer coating liquid and magnetic layer coating liquid can be simultaneously coated or successively coated.

Conducting magnetic field orientation step 14 while the magnetic layer coating liquid is wet is desirable from the perspective of ease of orientation. The magnetic field desirably ranges from 0.1 T·m to 1.0 T·m. In drying step 15, the various coating liquids are dried, after which the backcoat layer is coated and dried. Subsequently, film 11 on which the various layers have been formed is desirably calendered in calendering step 18, yielding magnetic tape 22. Conducting calendering step 18 can yield magnetic tape 22 with a smooth surface. Next, following calendering, the roll is subjected to heat relaxation and thermal curing step 19 for the purpose of relaxing the amount of excess enthalpy in the support, reduce the amount of heat shrinkage, and thermally curing the coating. The heat treatment is desirably conducted at a temperature of not more than 52° C. lower but more than 1° C. lower than the glass transition temperature of the support for a period of equal to or more than 1 hour and equal to or less than 14 days. In heat relaxation and thermal curing step 19, heating is desirably conducted with the magnetic recording medium wound up into a roll. Conducting the heat relaxation and thermal curing step with the magnetic recording medium in the form of a web is undesirable in that, to ensure productivity, the processing period may be limited to equal to or less than 100 seconds, curing may be inadequate, durability may decrease, and severe head grime may accumulate.

The protrusions of the surface of the backcoat layer are transferred to the surface of the magnetic layer, forming indentations, by heat relaxation and thermal curing step 19. In this state, the number of indentations equal to or greater than 20 nm in depth on the magnetic layer surface normally exceeds 100/10,000 μm², recording and reproduction signal dropout may occur, and the error rate may increase. To reduce the indentations on the magnetic layer surface, magnetic layer indentation reduction step 20 can be conducted in the form of a step such as those set forth below.

A. Calendering following heat relaxation and thermal curing step 19 The indentations in the magnetic layer can be relaxed after the heat treatment by calendering and winding up the stock material using a calendering apparatus comprised of a combination of metal rolls. The calendering conditions for relaxing the indentations can be identical to the calendering conditions used for smoothing following coating and drying of the magnetic layer, but to effectively reduce the indentations, calendering is desirably conducted at a temperature of 60 to 110° C., a linear pressure of 98 to 490 kN/m, and a speed of 50 to 300 m/min. For example, calendering can be conducted at a temperature of about 90° C., a linear pressure of about 343 kN/m, and a speed of about 100 m/min. A high temperature, high linear pressure, and low speed are desirable to effectively reduce the indentations, but to maintain the level of enthalpy relaxation through relaxation of the excess enthalpy conducted in heat relaxation and thermal curing step 19, calendering is desirably conducted in such a manner that the temperature of the support does not rise to or above the glass transition temperature of the support.

B. Web heat treatment following heat relaxation and thermal curing step 19 Indentations in the magnetic layer can also be reduced by heating while unwinding and conveying the stock material following heat relaxation and thermal curing step 19. A method such as hot air, heating with infrared radiation, or contact heating can be employed in web heating. To maintain the relaxation of excess enthalpy conducted in heat relaxation and thermal curing step 19, the web is desirably heated to a temperature of equal to or higher than 90° C. in such a manner that the temperature does not reach or exceed the glass transition temperature of the support, this being an upper limit. A temperature of less than 90° C. is undesirable in that the time required to reduce the indentations in the magnetic layer may be excessive and productivity may decrease. Although a long period of web heat treatment is desirable to promote reduction of indentations in the magnetic layer, from the perspective of ensuring productivity, the processing time desirably falls within a range of 0.01 s to 100 s. During heat treatment of the web, the tension applied to the web is desirably low to keep down the heat shrinkage rate, with equal to or greater than 1 MPa and equal to or less than 5 MPa being desirable. A tension of less than 1 MPa is undesirable in that stable conveying may be precluded and productivity may drop.

To reduce the indentations in the magnetic layer in above-described heat relaxation and thermal curing step 19, it is possible to omit magnetic layer indentation reduction step 20 by modifying the formula of the backcoat layer. Softening the composition of the binder employed in the backcoat layer is effective, but when the back layer is softened, the magnetic layer and the back layer tend to undergo blocking in heat relaxation and thermal curing step 19. Thus, softening is preferably conducted to a suitable degree. It is also possible to adjust the particle diameter of the carbon black that is employed in the backcoat layer to control the protrusions on the surface of the backcoat layer and reduce indentations in the magnetic layer.

As set forth above, in the magnetic recording medium of the present invention, the number of indentations equal to or greater than 20 nm in depth on the magnetic layer surface is equal to or less than 100/10,000 μm². The magnetic recording medium of the present invention is suitable for use in a magnetic recording and reproduction system employing a reproduction head the track width of which has been narrowed to equal to or less than 4.0 μm, for example. The reproduction head track width is desirably 0.8 to 3.6 μm. The reproduction with great sensitivity of a signal that has been recorded at high density is possible with a reproduction head with such a narrow track. The signal that is recorded desirably has a minimum recording bit length of about 10 to 100 nm.

### Magnetic Signal Reproduction Method and Magnetic Signal Reproduction System

The present invention further relates to:

a method of reproducing magnetic signals, comprising:

reproducing magnetic signals that have been recorded on the magnetic recording medium of the present invention with a reproduction head with a track width of equal to or less than 4.0 μm; and

a magnetic signal reproduction system, comprising:

the magnetic recording medium of the present invention, and

a reproduction head with a track width of equal to or less than 4.0 μm.

Details of the above method and the above system are as set forth above.

### EXAMPLES

The present invention will be described in detail below based on examples. However, the present invention is not limited to the examples. The term “parts” given in Examples are weight parts unless specifically stated otherwise.

### Example 1

2 Preparation of Magnetic Layer Coating Liquid (Formula 1)

| | | |
|---|---|---|
| Acicular ferromagnetic metal powder | 100 | parts |
| Composition: Fe/Co/Al/Y = 68/20/7/5 | | |
| Surface treatment agent: Al₂O₃, Y₂O₃ | | |
| Crystallite size: 125 Angstroms | | |
| Major axis diameter: 45 nm | | |
| Acicular ratio: 5 | | |
| Specific surface area by BET method: 42 m²/g | | |
| Coercivity (Hc): 180 kA/m | | |
| Saturation magnetization (σs): 135 A · m²/kg | | |
| Polyurethane resin | 12 | parts |
| Branched side chain-containing polyester | | |
| polyol/diphenylmethane diisocyanate | | |
| type, Hydrophilic polar group: —SO₃Na content is | | |
| 70 eq/ton. | | |
| Phenylphosphorous acid | 3 | parts |
| α-Al₂O₃ (particle size: 0.1 micrometer) | 2 | parts |
| Carbon black (particle size: 20 nm) | 2 | parts |
| Cyclohexanone | 110 | parts |
| Methyl ethyl ketone | 100 | parts |
| Toluene | 100 | parts |
| Butyl stearate | 2 | parts |
| Stearic acid | 1 | part |

2. Preparation of Nonmagnetic Layer Coating Liquid (Formula I)

| | | |
|---|---|---|
| Inorganic nonmagnetic powder | 85 | parts |
| α-iron oxide | | |
| Surface treatment agent: Al₂O₃, SiO₂ | | |
| Major axis diameter: 0.15 micrometer | | |
| Acicular ratio: 7 | | |
| Specific surface area by BET method: 50 m²/g | | |
| DBP oil absorption capacity: 33 g/100 g | | |
| pH: 8 | | |
| Carbon black | 20 | parts |
| Specific surface area by BET method: 250 m²/g | | |
| DBP oil absorption capacity: 120 ml/100 g | | |
| pH: 8 | | |
| Volatile content: 1.5 percent | | |
| Polyurethane resin | 12 | parts |
| Branched side chain-containing polyester | | |
| polyol/diphenylmethane diisocyanate | | |
| type, Hydrophilic polar group: —SO₃Na content is | | |
| 70 eq/ton. | | |
| Acrylic resin | 6 | parts |
| Benzyl methacrylate/diacetone acrylamide type, | | |
| Hydrophilic polar group: | | |
| —SO₃Na content is 60 eq/ton. | | |
| Phenylphosphorous acid | 3 | parts |
| α-Al₂O₃ (average particle diemeter: 0.2 micrometer) | 1 | parts |
| Cyclohexanone | 140 | parts |
| Methyl ethyl ketone | 170 | parts |
| Butyl stearate | 2 | parts |
| Stearic acid | 1 | part |

The various components of the above-described magnetic layer (upper layer) coating liquid and nonmagnetic layer (lower layer) coating liquid were kneaded for 60 minutes in an open kneader and then dispersed for 120 minutes in a sand mill. To the dispersions obtained were added 6 parts of a trifunctional low-molecular-weight polyisocyanate compound (Coronate 3041, made by Nippon Polyurethane Industry Co., Ltd.). The mixture was mixed and stirred for an additional 20 minutes and filtered with a filter having an average pore diameter of 1 micrometer to prepare a magnetic layer coating liquid and nonmagnetic layer coating liquid.

3. Preparation of Backcoat Layer Coating Liquid (Formula A)

### (Dispersion)

The composition given below was charged to a ball mill, after which dispersion processing was conducted for 24 hours.

| | | |
|---|---|---|
| Carbon black | 180 | parts |
| Conductex SC made by Columbia Carbon Co., Ltd. | | |
| Average particle diameter: 20 nm | | |
| Specific surface area by BET method: 220 m²/g | | |
| Carbon black | 25 | parts |
| Sevacarb MT made by Columbia Carbon Co., Ltd | | |
| Average particle diameter: 350 nm | | |
| Specific surface area by BET method: 8 m²/g | | |
| α-Fe₂O₃ | 1 | part |
| TF100 made by Toda Kogyo Corp. | | |
| Average particle diameter: 0.1 micrometer | | |
| Nitrocellulose resin | 65 | parts |
| Polyester polyurethane resin (UR-8300 made by | 35 | parts |
| Toyobo Co., Ltd.) | | |
| Methyl ethyl ketone (MEK) | 260 | parts |
| Toluene | 260 | parts |
| Cyclohexanone | 260 | parts |

The following composition was mixed into a slurry following dispersion and stirred, after which dispersion processing was conducted for another 3 hours in a ball mill.

| | |
|---|---|
| Stearic acid | 1 part |
| Butyl stearate | 2 parts |
| MEK | 210 parts |
| Toluene | 210 parts |
| Cyclohexanone | 210 parts |

To 100 weight parts of the coating material following filtration was added 1 weight part of isocyanate compound (Coronate L, made by Nippon Polyurethane Industry Co., Ltd.). The mixture was mixed, stirred, and filtered with a filter having an average pore diameter of 0.5 micrometer to prepare a backcoat layer coating liquid.

A magnetic tape was manufactured by the manufacturing process shown in FIG. 2 as described below.

The above-described nonmagnetic coating liquid was coated in a quantity calculated to yield a dry thickness of 1.0 micrometer to the magnetic layer forming side of a polyethylene naphthalate (PEN) film 11, that was 5 micrometers in thickness with a surface roughness of 3 nm on the magnetic layer forming side, a surface roughness of 8 nm on the reverse side and Tg of 127° C. Immediately thereafter, the magnetic layer coating liquid was coated in a simultaneous multilayer coating in a quantity calculated to yield a dry thickness of 0.1 micrometer (magnetic layer coating step 13). While both layers were still wet, magnetic field orientation was conducted with 300 T·m magnets (magnetic field orientation step 14) and dried (drying step 15). The tension in the longitudinal direction of the web during drying step 15 was 15 MPa. Subsequently, a backcoat layer was coated in a quantity calculated to yield a dry thickness of 0.5 micrometer on the reverse side of the base film from the surface on which the magnetic layer had been formed (backcoat layer coating step 16) and dried (drying step 17). Next, processing was conducted with a seven-stage calender comprised only of metal rolls at a temperature of 95° C., a speed of 100 m/min, and a linear pressure of 294 kN/min (calendering step 18). The stock material was then stored for 48 hours in a storage chamber heated to 85° C. in the form of a bulk roll (heat relaxation and thermal curing step 19). After renewed calendering under conditions identical to those in calendering step 18 (magnetic layer indentation reduction step 20), the stock material was slit to a ½ inch width (slitting step 21) to prepare a magnetic tape 22. A servo signal was written onto the magnetic tape 22 obtained in accordance with the LTO-G4 standard and 820 m of the tape was wound into an LTO-G4 cassette to manufacture a tape cartridge.

### Example 2

The processing temperature in heat relaxation and thermal curing step 19 following calendering in Example 1 was changed to 80° C. Further, since the processing temperature in heat relaxation and thermal curing step 19 was set lower than in Example 1 and the transfer of protrusions from the surface of the backcoat layer to the surface of the magnetic layer was reduced, the calendering temperature in magnetic layer indentation reduction step 20 was set to 85° C., which was lower than in Example 1. With the exception of the above, a tape cartridge was manufactured in the same manner as in Example 1.

### Example 3

The processing temperature in heat relaxation and thermal curing step 19 following calendering in Example 1 was changed to 77° C. Further, since the processing temperature in heat relaxation and thermal curing step 19 was set lower than in Example 1 and the transfer of protrusions from the surface of the backcoat layer to the surface of the magnetic layer was reduced, the calendering temperature in magnetic layer indentation reduction step 20 was set to 90° C., which was lower than in Example 1. With the exception of the above, a tape cartridge was manufactured in the same manner as in Example 1.

### Example 4

The processing temperature in heat relaxation and thermal curing step 19 following calendering in Example 1 was changed to 95° C. Further, since the processing temperature in heat relaxation and thermal curing step 19 was set higher than in Example 1 and the transfer of protrusions from the surface of the backcoat layer to the surface of the magnetic layer was increased, the calendering temperature in magnetic layer indentation reduction step 20 was set to 105° C., which was higher than in Example 1. With the exception of the above, a tape cartridge was manufactured by the same manner as in Example 1.

### Example 5

The processing temperature in heat relaxation and thermal curing step 19 following calendering in Example 1 was changed to 100° C. Further, since the processing temperature in heat relaxation and thermal curing step 19 was set higher than in Example 1 and the transfer of protrusions from the surface of the backcoat layer to the surface of the magnetic layer was increased, the calendering temperature in magnetic layer indentation reduction step 20 was set to 110° C., which was higher than in Example 1. With the exception of the above, a tape cartridge was manufactured by the same manner as in Example 1.

### Example 6

With the exception that the calendering temperature in magnetic layer indentation reduction step 20 in Example 1 was set to 100° C., a tape cartridge was manufactured by the same manner as in Example 1.

### Example 7

With the exception that the calendering temperature in magnetic layer indentation reduction step 20 in Example 1 was set to 90° C., a tape cartridge was manufactured by the same manner as in Example 1.

### Example 8

A base film adjusted to a Tg of 120° C. with a resin comprising 20 weight parts of polyetherimide (PEI) incorporated into PET was employed as nonmagnetic support 11. Since the base Tg was lower than the PEN base employed in Example 1 and enthalpy relaxation progressed readily, the processing temperature in heat relaxation and thermal curing step 19 following calendering was set to 80° C., which was lower than in Example 1. Since the processing temperature in heat relaxation and thermal curing step 19 was lower than in Example 1 and the transfer of protrusions from the surface of the backcoat layer to the surface of the magnetic layer was reduced, the calendering temperature in magnetic layer indentation reduction step 20 was set to 90° C., which was lower than in Example 1. With the exception of the above, a tape cartridge was manufactured by the same manner as in Example 1.

### Example 9

With the exception that a base film was employed in the form of the nonmagnetic support employed in Example 8 on both sides of which had been formed aluminum oxide layers (thickness of each layer: 70 nm) by vacuum deposition, a tape cartridge was manufactured by the same manner as in Example 1.

### Example 10

Instead of the calendering conducted as magnetic layer indentation reduction step 20 in Example 1, the roll of stock material was unwound, the web was conveyed in such a manner that it remained for 30 s in a zone heated to a temperature of 110° C., and the web was cooled to room temperature and rolled up. With the exception of the above, a tape cartridge was manufactured by the same manner as in Example 1.

### Example 11

With the exceptions that the backcoat layer coating liquid was changed (formula B) and magnetic layer indentation reduction step 20 was not conducted, a tape cartridge was manufactured by the same manner as in Example 1.

3. Preparation of the Backcoat Layer Coating Liquid (Formula B)

### (Dispersion)

The composition given below was charged to a ball mill, after which dispersion processing was conducted for 24 hours.

| | |
|---|---|
| Carbon black | 180 parts |
| Regal 250 made by Cabot Corp. | |
| Average particle diameter: 34 nm | |
| Specific surface area by BET method: 55 m²/g | |
| Carbon black | 25 parts |
| Black Pearls 130 made by Cabot Corp. | |
| Average particle diameter: 75 nm | |
| Specific surface area by BET method: 25 m²/g | |
| α-Fe₂O₃ | 1 part |
| TF100 made by Toda Kogyo Corp. | |
| Average particle diameter: 0.1 micrometer | |
| Nitrocellulose resin | 35 parts |
| Polyester polyurethane resin (UR-8300 made by | 65 parts |
| Toyobo Co., Ltd.) | |
| MEK | 260 parts |
| Toluene | 260 parts |
| Cyclohexanone | 260 parts |

The following composition was mixed into a slurry following dispersion and stirred, after which dispersion processing was conducted for another 3 hours in a ball mill.

| | |
|---|---|
| Stearic acid | 1 part |
| Butyl stearate | 2 parts |
| MEK | 210 parts |
| Toluene | 210 parts |
| Cyclohexanone | 210 parts |

To 100 weight parts of the coating material following filtration was added one weight part of isocyanate compound (Coronate L, made by Nippon Polyurethane Industry Co., Ltd.). The mixture was mixed, stirred, and filtered with a filter having an average pore diameter of 0.5 micrometer to obtain a backcoat layer coating liquid.

### Example 12

With the exception that the magnetic layer coating liquid was replaced with a coating liquid (formula 2) in which ferromagnetic plate-shaped hexagonal ferrite powder was employed, a tape cartridge was manufactured in the same manner as in Example 1.

1. Preparation of Magnetic Layer Coating Liquid (Formula 2)

| | | |
|---|---|---|
| Ferromagnetic plate-shaped hexagonal ferrite powder | 100 | parts |
| Composion (molar ratio): Ba/Fe/Co/Zn = 1/9/0.2/0.8 | | |
| Plate diameter: 30 nm | | |
| Plate ratio: 3 | | |
| Specific surface area by BET method: 50 m²/g | | |
| Coercivity (Hc): 191 kA/m | | |
| Saturation magnetization (σs): 60 A · m²/kg | | |
| Polyurethane resin | 12 | parts |
| Branched side chain-containing polyester | | |
| polyol/diphenylmethane diisocyanate | | |
| type, Hydrophilic polar group: —SO₃Na content is | | |
| 70 eq/ton. | | |
| Phenylphosphorous acid | 3 | parts |
| α-Al₂O₃ (particle size: 0.15 micrometer) | 2 | parts |
| Carbon black (particle size: 20 nm) | 2 | parts |
| Cyclohexanone | 110 | parts |
| Methyl ethyl ketone | 100 | parts |
| Toluene | 100 | parts |
| Butyl stearate | 2 | parts |
| Stearic acid | 1 | part |

### Example 13

With the exception that the tension applied to the web in the longitudinal direction in drying step 15 in Example 1 was changed to 3 MPa, a tape cartridge was manufactured in the same manner as in Example 1.

### Example 14

With the exception that the tension applied to the web in the longitudinal direction in drying step 15 in Example 1 was changed to 25 MPa, a tape cartridge was manufactured in the same manner as in Example 1.

### Example 15

With the exception that the tension applied to the web in the longitudinal direction in drying step 15 in Example 1 was changed to 30 MPa, a tape cartridge was manufactured in the same manner as in Example 1.

### Example 16

With the exception that a base film was employed in the form of a nonmagnetic support, identical to the nonmagnetic support employed in Example 1, on both sides of which had been formed aluminum oxide layers (thickness of each layer: 300 nm) by vacuum deposition, a tape cartridge was manufactured by the same manner as in Example 1.

### Comparative Example 1

The nonmagnetic support 11 employed in Example 1 was heated with a processing apparatus having a 120° C. heat treatment zone, wound up, stored for 1 week in a processing apparatus at 110° C. in roll form, and subjected to relaxation (heat relaxation step 12). After conducting manufacturing steps 13 through 18 in identical fashion to Example 1, the processing conditions in heat relaxation and thermal curing step 19 after calendering were changed to 70° C. and 48 hours. Magnetic layer indentation reduction step 20 was not conducted. With the exception of the above, a tape cartridge was manufactured by the same manner as in Example 1.

### Comparative Example 2

The nonmagnetic support 11 employed in Example 1 was heated with a processing apparatus having a 120° C. heat treatment zone, wound up, stored for 1 week in a processing apparatus at 110° C. in roll form, and subjected to relaxation (heat relaxation step 12). After conducting manufacturing steps 13 through 18 in identical fashion to Example 1, heat relaxation and thermal curing step 19 following calendering was conducted not in roll form, but in web form at 110° C. for 10 seconds. Magnetic layer indentation reduction step 20 was not conducted. With the exception of the above, a tape cartridge was manufactured by the same manner as in Example 1.

### Comparative Example 3

The nonmagnetic support 11 employed in Example 1 was replaced with an aramid support (product name: Mictron) having a center surface average surface roughness of 2 nm and a thickness of 4.4 micrometers.

Preparation of Magnetic Layer Coating Liquid (Formula 3)

| | | |
|---|---|---|
| Ferromagnetic plate-shaped hexagonal ferrite powder | 100 | parts |
| Surface treatment: Al₂O₃: 5 weight percent, SiO₂: | | |
| 2 weight percent | | |
| Coercivity (Hc): 199 kA/m | | |
| Plate diameter: 0.03 micrometer | | |
| Plate ratio: 3 | | |
| Saturation magnetization (σs): 56 A · m²/kg | | |
| Vinyl chloride polymer MR 555 made by Nippon | 6 | parts |
| Zeon Co., Ltd. | | |
| Polyurethane resin UR8200 made by Toyobo Co., Ltd. | 6 | parts |
| α-alumina HIT55 made by Sumitomo Chemical Co., Ltd. | 2 | parts |
| (particle size: 0.3 micrometer) | | |
| Carbon black #55 Asahi Carbon Co., Ltd. | 5 | parts |
| (particle size: 20 nm) | | |
| Butyl stearate | 1 | part |
| Stearic acid | 2 | parts |
| Methyl ethyl ketone | 125 | parts |
| Cyclohexanone | 125 | parts |

2. Preparation of Nonmagnetic Layer Coating Liquid (Formula II)

| | | |
|---|---|---|
| Nonmagnetic powder acicular α-Fe₂O₃ | 75 | parts |
| DPN-250BX made by Toda Kogyo Corp. | | |
| Major axis length: 0.15 micrometer | | |
| Specific surface area: 53 m²/g | | |
| Carbon black | 20 | parts |
| CONDUCTEX SC-U made by Columbia Carbon Co., Ltd | | |
| Vinyl chloride copolymer MR110 made by Nippon | 12 | parts |
| Zeon Co., Ltd. | | |
| Polyurethane resin UR8200 made by Toyobo Co., Ltd. | 5 | parts |
| Phenylphosphorous acid | 4 | parts |
| Butyl stearate | 1 | part |
| Stearic acid | 3 | parts |
| Mixed solvent of methyl ethyl ketone and | 250 | parts |
| cyclohexanone (8:2) | | |

3. Preparation of Backcoat Layer Coating Liquid (Formula C)

The composition given below was charged to a ball mill, after which dispersion processing was conducted for 24 hours.

| | | |
|---|---|---|
| Carbon black | 180 | parts |
| Conductex SC made by Columbia Carbon Co., Ltd. | | |
| Average particle diameter: 20 nm | | |
| Specific surface area S_{BET}: 220 m²/g | | |
| Carbon black | 25 | parts |
| Sevacarb MT made by Columbia Carbon Co., Ltd. | | |
| Average particle diameter: 350 nm | | |
| Specific surface area S_{BET}: 8 m²g | | |
| α-Fe₂O₃ | 1 | part |
| (TF100 made by Toda Kogyo Corp., average particle | | |
| diameter: 0.1 micrometer) | | |
| Nitrocellulose resin | 65 | parts |
| Polyester polyurethane resin (UR-8300 made by | 35 | parts |
| Toyobo Co., Ltd.) | | |
| MEK | 260 | parts |
| Toluene | 260 | parts |
| Cyclohexanone | 260 | parts |

The following composition was mixed into a slurry following dispersion and stirred, after which dispersion processing was conducted for another 3 hours in a ball mill.

| | |
|---|---|
| Stearic acid | 1 part |
| Butyl stearate | 2 parts |
| MEK | 210 parts |
| Toluene | 210 parts |
| Cyclohexanone | 210 parts |

To 100 parts of the coating material following filtration was added 1 part of isocyanate compound (Coronate L, made by Nippon Polyurethane Industry Co., Ltd.). The mixture was stirred and mixed to obtain a backcoat layer coating liquid.

The various components of the above-described magnetic layer coating liquid (Formula 3) and nonmagnetic coating liquid (Formula II) were kneaded in a kneader and then dispersed for 12 hours in a sand mill. To the dispersion of nonmagnetic layer coating liquid obtained were added 2.5 parts of polyisocyanate, and to the dispersion of the magnetic layer coating liquid obtained were added 3 parts of polyisocyanate; 40 parts of cyclohexanone were added to each. The mixtures were then filtered using a filter having an average pore diameter of 1 micrometer to prepare a nonmagnetic layer coating liquid and a magnetic layer coating liquid. The nonmagnetic layer coating liquid obtained was coated in a quantity calculated to yield a dry nonmagnetic layer 1.7 micrometers in thickness, and immediately thereafter, the magnetic layer coating liquid was coated in a quantity calculated to yield a dry magnetic layer 0.15 micrometer in thickness, on an aramid support 11 (product name: Mictron) having a center surface average surface roughness of 2 nm and a thickness of 4.4 micrometers in a simultaneous multilayer coating (magnetic layer coating step 13). While the two layers were still wet, orientation was conducted with cobalt magnets having a magnetic force of 600 T·m (6,000 G) and solenoids having a magnetic force of 600 T·m (6,000 G) (magnetic field orientation step 14). After drying (drying step 15), processing was conducted at a temperature of 85° C. and a speed of 200 m/min with a seven-stage calender comprised only of metal rolls (calendering step 18). Subsequently, a backcoat was coated to a thickness of 0.6 micrometer (backcoat layer coating step 16) and then dried (drying step 17). A heat treatment was conducted for 48 hours at 70° C. (heat relaxation and thermal curing step 19). No magnetic layer indentation reduction step 20 was conducted. Subsequently, the stock material was slit to ½ inch width (slitting step 21) to manufacture a magnetic tape 22. A servo signal was written in accordance with the LTO-G4 standard on the magnetic tape 22 that had been obtained and 820 m of the tape was wound into an LTO-G4 cassette to manufacture a tape cartridge.

### Comparative Example 4

The conditions of heat relaxation and thermal curing step 19 following calendering step 18 in Example 1 were changed to 70° C. and 48 hours and no magnetic layer indentation reduction step 20 was conducted. With the exception of the above, a tape cartridge was manufactured under the same conditions as in Example 1.

### Comparative Example 5

The conditions of heat relaxation and thermal curing step 19 following calendering step 18 in Example 1 were changed to 73° C. and 48 hours and the calendering temperature in magnetic layer indentation reduction step 20 was changed to 85° C. With the exception of the above, a tape cartridge was manufactured under the same conditions as in Example 1.

### Comparative Example 6

The conditions of heat relaxation and thermal curing step 19 following calendering step 18 in Example 1 were changed to 115° C. and 48 hours and the calendering temperature in magnetic layer indentation reduction step 20 was changed to 110° C. With the exception of the above, a tape cartridge was manufactured under the same conditions as in Example 1.

### Comparative Example 7

The nonmagnetic support 11 in Example 1 was replaced with a PET (polyethylene terephthalate) film with a Tg of 80° C. The conditions of heat relaxation and thermal curing step 19 following calendering step 18 were changed to 70° C. and 48 hours, and the calendering temperature in magnetic layer indentation reduction step 20 was changed to 70° C. With the exception of the above, a tape cartridge was manufactured under the same conditions as in Example 1.

### Comparative Example 8

A base film adjusted to a Tg of 160° C. with a resin comprising 20 weight parts of polyetherimide (PEI) incorporated into PEN was employed as nonmagnetic support 11. Since the base Tg was higher than that of the PEN base employed in Example 1 and enthalpy relaxation tended not to progress, the processing temperature of heat relaxation and thermal curing step 19 following calendering was set to 115° C., which was higher than in Example 1. Further, since the processing temperature of heat relaxation and thermal curing step 19 was higher than in Example 1 and the transfer of protrusions on the surface of the backcoat to the surface of the magnetic layer tended to increase, the calendering temperature of magnetic layer indentation reduction step 20 was set to 110° C., which was higher than in Example 1. With the exception of the above, a tape cartridge was manufactured under the same conditions as in Example 1.

### <Measurement Methods>

1. Measurement of the Amount of Enthalpy Relaxation (ΔH)

The magnetic layer, nonmagnetic layer, and backcoat layer of the magnetic tape were stripped away with methyl ethyl ketone, yielding nonmagnetic support 11. A 10 mg quantity of nonmagnetic support 11 was weighed out. The area of the peak in the vicinity of Tg in the nonreversible heat flow obtained by measurement at a rate of temperature increase of 10° C./min, a temperature modulation period of 30 s, and a temperature modulation amplitude of 0.5° C. using a DSC Q100 made by TA Instruments was adopted as the amount of enthalpy relaxation (ΔH).

2. Method of Measuring the Number of Indentations in the Magnetic Layer Surface

The three-dimensional roughness of the magnetic layer was measured with a Nanoscope III made by Digital Instruments of the U.S. and the number of indentations equal to or greater than 20 nm in depth from the average plane was counted. The “average plane” was the plane for which the volume of indentations equaled the volume of protrusions within the measurement plane. Measurement was conducted for a range of 100×100 micrometers (10,000 square micrometers) and the data were processed with Nanoscope 5.30 analysis software. The measured data were subjected to flattening filtration under “Flatten order 3” conditions, after which the number of indentations was counted.

3. Method of Measuring the Tg of the Nonmagnetic Support

The glass transition temperature Tg is a value that is measured based on the temperature of the peak loss tangent (tanδ) in dynamic viscoelasticity measurement at 1 Hz. By employing a DMS 6100 connected to a dynamic viscoelasticity measuring device (EXSTAR 6000 Station, made by Seiko Instruments), measurement was made at 1 Hz at temperatures from 15° C. to 200° C. and the temperature of the peak loss tangent (tanδ) was obtained.

4. Method of Measuring the Sol Component Ratio

A 0.5 g quantity of the magnetic layer was weighed out from the magnetic layer formed on the nonmagnetic support for use in measuring the sol component ratio, and immersed for 30 minutes in 50 mL of hexane to extract the lubricant. The hexane was removed and the sample was immersed for 1 hour in 80 mL of THF to dissolve out the binder sol component. The THF and the binder solution that had dissolved out were evaporated. The lubricant was then extracted again with hexane and the sample was dried in a vacuum drier. The sol component was weighed and the sol component ratio was calculated.

5. Method of Measuring the Heat Shrinkage Rate

The sample was cut into reed-shaped sections measuring 150 mm in length by 12.65 mm in width in the longitudinal direction of the magnetic recording medium. Pairs of marks separated by a 100 mm gap in the longitudinal direction were made in the samples. The spacing (L1) between marks was measured with a measuring microscope at 23° C. and 50 percent RH. The samples were then stored for 48 hours without load in a thermostatic chamber kept at 70° C. They were removed to 23° C. and 50 percent RH, left standing for 30 minutes or more, and the spacing (L2) between the pairs of marks was measured with a measuring microscope. The rate of change (100×(L1−L2)/L1) in spacing between the marks before and after storage was adopted as the heat shrinkage rate (%). A heat shrinkage rate of equal to or less than 0.2 percent was evaluated as “Good” and one of greater than 0.2 percent as “Poor”.

6. Method of Measuring Dropout

A signal with a recording wavelength of 0.12 micrometer was recorded with a recording head having a track width of 4.5 micrometers. When the signal was reproduced with a GMR reproduction head having a track width of 3.0 micrometers, the number of times the output dropped by equal to or greater than 30 percent per meter of tape length was calculated as the dropout number. One dropout or less per meter was evaluated as “Good”.

7. Method of Measuring the Tape Width Change Rate

1) Measurement of the tape width change rate in an operating environment A stress of 10.8 MPa was applied in the longitudinal direction of the tape in a thermohydrostatic chamber kept at 10° C. and 10 percent RH, and an LSM-503S laser scan micrometer made by Mitsutoyo was used to measure the tape width W1. The environment within the thermohydrostatic chamber was then changed to 29° C. and 80 percent RH, and the tape width W2 was measured while the stress of 7.2 MPa was being applied in the longitudinal direction of the tape. (W−W1)/W1 was adopted as the tape width change rate in an operating environment in units of ppm.

2) Measurement of the Tape Width Change Rate Following Storage

A stress of 9 MPa was applied in the longitudinal direction of the tape in a thermohydrostatic chamber kept at 25° C. and 20 percent RH. An LSM-503S laser scan micrometer made by Mitsutoyo was used to measure the tape width W0. The environment within the thermohygrostatic chamber was then changed to 40° C. and 20 percent RH, and the tape was stored for 10 days while the stress of 9 MPa was being applied in the longitudinal direction of the tape. The environment within the thermohygrostatic chamber was then returned to 25° C. and 20 percent RH and the tape width Ws was measured while the stress of 9 MPa was being applied in the longitudinal direction of the tape. (Ws−W0)/W0 was adopted as the tape width change rate following storage in units of ppm.

3) Calculation of the Tape Width Change Rate

The “tape width change rate” was calculated in units of ppm by adding the “tape width change rate in an operating environment” and “tape width change rate following storage” obtained by the above methods. A tape width change rate of equal to or lower than 700 ppm was evaluated as “Good”, and a value exceeding 700 ppm as “Poor”.

8. Method of Measuring Processing Breakage

Under the processing conditions described in Examples and Comparative Examples, 10 base rolls, each of which was 10,000 m in length, were used to fabricate samples. The number of times the sample broke from step 12 to step 21 was determined. It was desirable for no breaks to occur.

9. Head Grime After 2,000 Running Passes

Two thousand passes of full-length running were conducted in an LTO-G4 drive and the head grime was observed following running. Those samples that exhibited grime under a microscope (400×) were evaluated as “Poor” and those that did not as “Good”.

The results are given in Table 1.

TABLE 1

| | Ferromagnetic | | Nonmagnetic | | Heat treatment | |
|---|---|---|---|---|---|---|
| | powder | Magnetic layer | lower layer | Support | for the support | Backcoat layer |
| Ex. 1 | MP | Formula 1 | Formula I | PEN | — | Formula A |
| Ex. 2 | MP | Formula 1 | Formula I | PEN | — | Formula A |
| Ex. 3 | MP | Formula 1 | Formula I | PEN | — | Formula A |
| Ex. 4 | MP | Formula 1 | Formula I | PEN | — | Formula A |
| Ex. 5 | MP | Formula 1 | Formula I | PEN | — | Formula A |
| Ex. 6 | MP | Formula 1 | Formula I | PEN | — | Formula A |
| Ex. 7 | MP | Formula 1 | Formula I | PEN | — | Formula A |
| Ex. 8 | MP | Formula 1 | Formula I | PET/PEI | — | Formula A |
| Ex. 9 | MP | Formula 1 | Formula I | Alumina-deposited base | — | Formula A |
| Ex. 10 | MP | Formula 1 | Formula I | PEN | — | Formula A |
| Ex. 11 | MP | Formula 1 | Formula I | PEN | — | Formula B |
| Ex. 12 | BF | Formula 2 | Formula I | PEN | — | Formula A |
| Ex. 13 | MP | Formula 1 | Formula I | PEN | — | Formula A |
| Ex. 14 | MP | Formula 1 | Formula I | PEN | — | Formula A |
| Ex. 15 | MP | Formula 1 | Formula I | PEN | — | Formula A |
| Ex. 16 | MP | Formula 1 | Formula I | PEN | — | Formula A |
| Comp. Ex. 1 | MP | Formula 1 | Formula I | PEN | 110° C. | Formula A |
| | | | | | 1 week | |
| Comp. Ex. 2 | MP | Formula 1 | Formula I | PEN | 110° C. | Formula A |
| | | | | | 1 week | |
| Comp. Ex. 3 | BF | Formula 3 | Formula II | Aramid | — | Formula C |
| Comp. Ex. 4 | MP | Formula 1 | Formula I | PEN | — | Formula A |
| Comp. Ex. 5 | MP | Formula 1 | Formula I | PEN | — | Formula A |
| Comp. Ex. 6 | MP | Formula 1 | Formula I | PEN | — | Formula A |
| Comp. Ex. 7 | MP | Formula 1 | Formula I | PET | — | Formula A |
| Comp. Ex. 8 | MP | Formula 1 | Formula I | PEN/PEI | — | Formula A |

Note)
MP: Ferromagnetic metal powder,
BF: Ferromagnetic hexagonal ferrite powder

| | Tension in the coating | Heat relaxation and thermal | |
|---|---|---|---|
| | film drying zone | curing treatment | Indentation reduction treatment |
| Ex. 1 | 15 MPa | 85° C. 48 h | Calendering at 95° C. |
| Ex. 2 | 15 MPa | 75° C. 48 h | Calendering at 85° C. |
| Ex. 3 | 15 MPa | 80° C. 48 h | Calendering at 90° C. |
| Ex. 4 | 15 MPa | 95° C. 48 h | Calendering at 105° C. |
| Ex. 5 | 15 MPa | 100° C. 48 h | Calendering at 110° C. |
| Ex. 6 | 15 MPa | 85° C. 48 h | Calendering at 105° C. |
| Ex. 7 | 15 MPa | 85° C. 48 h | Calendering at 85° C. |
| Ex. 8 | 15 MPa | 80° C. 48 h | Calendering at 90° C. |
| Ex. 9 | 15 MPa | 80° C. 48 h | Calendering at 90° C. |
| Ex. 10 | 15 MPa | 85° C. 48 h | Web heating at 110° C. |
| Ex. 11 | 15 MPa | 85° C. 48 h | — |
| Ex. 12 | 15 MPa | 85° C. 48 h | Calendering at 95° C. |
| Ex. 13 | 3 MPa | 85° C. 48 h | Calendering at 95° C. |
| Ex. 14 | 25 MPa | 85° C. 48 h | Calendering at 95° C. |
| Ex. 15 | 30 MPa | 85° C. 48 h | Calandering at 95° C. |
| Ex. 16 | 15 MPa | 85° C. 48 h | Calendering at 95° C. |
| Comp. Ex. 1 | 15 MPa | 70° C. 48 h | — |
| Comp. Ex. 2 | 15 MPa | Web heating at 110° C. for 10 sec | — |
| Comp. Ex. 3 | 15 MPa | 70° C. 48 h | — |
| Comp. Ex. 4 | 15 MPa | 70° C. 48 h | — |
| Comp. Ex. 5 | 15 MPa | 73° C. 48 h | Calendering at 85° C. |
| Comp. Ex. 6 | 15 MPa | 115° C. 48 h | Calendering at 110° C. |
| Comp. Ex. 7 | 15 MPa | 70° C. 48 h | Calendering at 70° C. |
| Comp. Ex. 8 | 15 MPa | 115° C. 48 h | Calendering at 110° C. |

| | | |
|---|---|---|
| Amount of | Number of | |
| enthalpy relaxation | indentatioins | Tg of the support |
| (J/g) | per 10000 um² | (° C.) |

| | | | | | | |
|---|---|---|---|---|---|---|
| Ex. 1 | 1.0 | Good | 60 | Good | 127 | Good |
| Ex. 2 | 0.6 | Good | 60 | Good | 127 | Good |
| Ex. 3 | 0.7 | Good | 60 | Good | 127 | Good |
| Ex. 4 | 1.8 | Good | 70 | Good | 127 | Good |
| Ex. 5 | 1.9 | Good | 90 | Good | 127 | Good |
| Ex. 6 | 1.0 | Good | 30 | Good | 127 | Good |
| Ex. 7 | 1.0 | Good | 85 | Good | 127 | Good |
| Ex. 8 | 1.0 | Good | 60 | Good | 120 | Good |
| Ex. 9 | 1.0 | Good | 60 | Good | 120 | Good |
| Ex. 10 | 1.0 | Good | 85 | Good | 127 | Good |
| Ex. 11 | 1.0 | Good | 80 | Good | 127 | Good |
| Ex. 12 | 1.0 | Good | 40 | Good | 127 | Good |
| Ex. 13 | 1.0 | Good | 35 | Good | 127 | Good |
| Ex. 14 | 1.0 | Good | 60 | Good | 127 | Good |
| Ex. 15 | 1.0 | Good | 80 | Good | 127 | Good |
| Ex. 16 | 1.0 | Good | 20 | Good | 127 | Good |
| Comp. Ex. 1 | 1.9 | Good | 150 | Poor | 127 | Good |
| Comp. Ex. 2 | 1.9 | Good | 25 | Good | 127 | Good |
| Comp. Ex. 3 | 0.0 | Poor | 140 | Poor | 280 | Poor |
| Comp. Ex. 4 | 0.2 | Poor | 170 | Poor | 127 | Good |
| Comp. Ex. 5 | 0.4 | Poor | 55 | Good | 127 | Good |
| Comp. Ex. 6 | 2.2 | Poor | 95 | Good | 127 | Good |
| Comp. Ex. 7 | 1.0 | Good | 90 | Good | 80 | Poor |
| Comp. Ex. 8 | 1.0 | Good | 140 | Poor | 160 | Poor |

| | | |
|---|---|---|
| Sol component ratio in the | Heat shrinkage rate | Dropout |
| magnetic layer (%) | (%) | (per m) |

| | | | | | | |
|---|---|---|---|---|---|---|
| Ex. 1 | 1.8 | Good | 0.12 | Good | 0.3 | Good |
| Ex. 2 | 2.4 | Good | 0.16 | Good | 0.3 | Good |
| Ex. 3 | 2.0 | Good | 0.13 | Good | 0.3 | Good |
| Ex. 4 | 1.4 | Good | 0.10 | Good | 0.5 | Good |
| Ex. 5 | 1.2 | Good | 0.09 | Good | 0.9 | Good |
| Ex. 6 | 1.8 | Good | 0.13 | Good | 0.1 | Good |
| Ex. 7 | 1.8 | Good | 0.11 | Good | 0.8 | Good |
| Ex. 8 | 1.8 | Good | 0.18 | Good | 0.3 | Good |
| Ex. 9 | 1.8 | Good | 0.18 | Good | 0.8 | Good |
| Ex. 10 | 1.8 | Good | 0.15 | Good | 0.8 | Good |
| Ex. 11 | 1.8 | Good | 0.12 | Good | 0.7 | Good |
| Ex. 12 | 1.8 | Good | 0.12 | Good | 0.1 | Good |
| Ex. 13 | 1.8 | Good | 0.05 | Good | 0.1 | Good |
| Ex. 14 | 1.8 | Good | 0.19 | Good | 0.3 | Good |
| Ex. 15 | 1.8 | Good | 0.22 | Poor | 0.7 | Good |
| Ex. 16 | 1.8 | Good | 0.03 | Good | 0.1 | Good |
| Comp. Ex. 1 | 3.1 | Good | 0.26 | Poor | 5.0 | Poor |
| Comp. Ex. 2 | 8.6 | Poor | 0.26 | Poor | 0.1 | Good |
| Comp. Ex. 3 | 2.9 | Good | 0.12 | Good | 4.0 | Poor |
| Comp. Ex. 4 | 3.1 | Good | 0.25 | Poor | 6.5 | Poor |
| Comp. Ex. 5 | 2.6 | Good | 0.22 | Poor | 0.8 | Good |

| | | | | |
|---|---|---|---|---|
| Comp. Ex. 6 | 1.0 | Good | Measurement could not be | Measurement could not be |
| | | | carried out because of | carried out because of web |
| | | | web deformation. | deformation. |

| | | | | | | |
|---|---|---|---|---|---|---|
| Comp. Ex. 7 | 3.0 | Good | 0.27 | Poor | 0.9 | Good |
| Comp. Ex. 8 | 1.0 | Good | 0.11 | Good | 2.6 | Poor |

| | | | | |
|---|---|---|---|---|
| | Tape width | | | Head |
| Tape width change | change rate | | | grime |
| rate in an operation | following | Tape width | | after |
| environment | storage | change rate | Processing | 2000 |
| (ppm) | (ppm) | (ppm) | breakage | passes |

| Ex. 1 | 700 | 50 | 750 | Good | None | Good |
|---|---|---|---|---|---|---|
| Ex. 2 | 700 | 90 | 790 | Good | None | Good |
| Ex. 3 | 700 | 60 | 760 | Good | None | Good |
| Ex. 4 | 700 | 20 | 720 | Good | None | Good |
| Ex. 5 | 700 | 20 | 720 | Good | None | Good |
| Ex. 6 | 700 | 50 | 750 | Good | None | Good |
| Ex. 7 | 720 | 50 | 750 | Good | None | Good |
| Ex. 8 | 720 | 60 | 780 | Good | None | Good |
| Ex. 9 | 600 | 40 | 640 | Good | None | Good |
| Ex. 10 | 700 | 70 | 770 | Good | None | Good |
| Ex. 11 | 700 | 50 | 750 | Good | None | Good |
| Ex. 12 | 700 | 50 | 750 | Good | None | Good |
| Ex. 13 | 700 | 40 | 740 | Good | None | Good |
| Ex. 14 | 700 | 60 | 760 | Good | None | Good |
| Ex. 15 | 700 | 90 | 790 | Good | None | Good |
| Ex. 16 | 210 | 30 | 240 | Good | None | Good |
| Comp. Ex. 1 | 700 | 50 | 750 | Good | None | Good |
| Comp. Ex. 2 | 700 | 50 | 750 | Good | None | Poor |
| Comp. Ex. 3 | 350 | 50 | 400 | Good | 6 times | Good |
| Comp. Ex. 4 | 700 | 170 | 870 | Poor | None | Good |
| Comp. Ex. 5 | 700 | 130 | 830 | Poor | None | Good |
| Comp. Ex. 6 | Measurement could not be carried out because of web | | | | None | Good |
| | deformation | | | | | |
| Comp. Ex. 7 | 900 | 200 | 1100 | X | None | Good |
| Comp. Ex. 8 | 650 | 40 | 690 | ◯ | 2 times | Good |

### Evaluation Results

As shown in Table 1, Examples 1 to 16 exhibited little dropout, good tape width change rate, no breakage during processing, and no head grime at 2,000 passes.

In Comparative Example 1, heat relaxation and thermal curing step 19 produced indentations in the magnetic layer. Since indentation reduction step 20 was not subsequently conducted, the number of indentations on the surface of the magnetic layer was large. Since heat relaxation step 12 was conducted on the support, the amount of enthalpy relaxation in the support was high and the tape width change rate when stored at high temperature was good. However, the large number of magnetic layer indentations caused substantial dropout, and the tape was not suitable as a high-density recording medium.

In Comparative Example 2, heat relaxation and thermal curing step 19 was performed for 10 s at 110° C. not in a roll form, but in a web form. Thus, curing of the magnetic layer was inadequate, there was a high sol component ratio, head grime occurred after 2,000 passes, and the tape was not suitable as a magnetic recording medium.

In Comparative Example 3, aramid with a high glass transition temperature Tg was employed as the nonmagnetic support. Thus, the processing temperature in heat relaxation and thermal curing step 19 was low relative to the support Tg and no enthalpy relaxation was generated. A high Young's modulus resulted in a good tape width change rate. However, breaks occurred during processing and productivity dropped. Since indentation relaxation step 20 was not carried out, there was a large number of indentations on the surface of the magnetic layer, substantial dropout occurred, and the tape was not suitable as a high-density recording medium.

In Comparative Example 4, the processing temperature in heat relaxation and thermal curing step 19 was low relative to the support Tg and there was little enthalpy relaxation. Thus, the tape width change rate was high. Further, since no indentation relaxation step 20 was carried out, there was a large number of indentations on the surface of the magnetic layer, substantial dropout occurred, and the tape was not suitable as a high-density recording medium.

In Comparative Example 5, the processing temperature in heat relaxation and thermal curing step 19 was low relative to the support Tg and the amount of enthalpy relaxation, at 0.4 J/g, was insufficient. Thus, the tape width change rate was high and the tape was unsuitable as a high-density recording medium.

In Comparative Example 6, the processing temperature in heat relaxation and thermal curing step 19 was close to the support Tg and the amount of enthalpy relaxation, at 2.2 J/g, was high, but the web distorted, precluding evaluation.

In Comparative Example 7, PET with a Tg of 80° C. was employed as the nonmagnetic support, so the amount of enthalpy relaxation was 0.8 J/g. However, a low Young's modulus resulted in a high tape width change rate in an operating environment. Further, the tape tended to extend in the drying step due to the low Tg and Young's modulus and the heat shrinkage rate was increased. Thus, the tape width change rate following storage was high, and the tape was not suitable as a high-density recording medium.

In Comparative Example 8, a base film with a Tg of 160° C. in the form of a blended resin of PEN and PEI (polyetherimide) was employed as the nonmagnetic support. Thus, to achieve an amount of enthalpy relaxation of 1.0 J/g, it was necessary to raise the temperature in heat relaxation and thermal curing step 19 relative to what it was for the PEN film with a Tg of 127° C. employed in Example 1. Since the number of indentations due to the transfer of protrusions on the surface of the backcoat layer to the surface of the magnetic layer in heat relaxation and thermal curing step 19 increased, the calendering temperature in magnetic layer indentation reduction step 20 was set to 110° C., which was higher than in Example 1. However, the indentations in the magnetic layer were not adequately reduced, resulting in increased dropout. Further, the high Tg of the base film caused breaks during processing and compromised productivity.

The magnetic recording medium of the present invention can exhibit good electromagnetic characteristics and dimensional stability for long periods, afford good running durability, and is thus suitable as a backup tape in which high reliability is required for extended periods.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A magnetic recording medium comprising a magnetic layer comprising a ferromagnetic powder and a binder on one surface of a nonmagnetic support and a backcoat layer on the other surface of the nonmagnetic support, wherein
a number of indentations equal to or greater than 20 nm in depth present on the magnetic layer surface is equal to or less than 100/10,000 μm²,
a sol component ratio in the magnetic layer is equal to or less than 5.0 percent, and
the support has an amount of heat absorption based on enthalpy relaxation ranging from 0.5 J/g to 2.0 J/g, and a glass transition temperature Tg ranging from 110° C. to 140° C.

2. The magnetic recording medium according to claim 1, which has a heat shrinkage rate of equal to or less than 0.20 percent.

3. The magnetic recording medium according to claim 1, which is a tape-shaped magnetic recording medium having a tape width change rate of equal to or less than 800 ppm.

4. The magnetic recording medium according to claim 1, wherein the number of indentations equal to or greater than 20 nm in depth present on the magnetic layer surface ranges from 2/10,000 μm² to 90 /10,000 μm².

5. The magnetic recording medium according to claim 1, wherein the number of indentations equal to or greater than 20 nm in depth present on the magnetic layer surface ranges from 2/10,000 μm² to 70/10,000 μm².

6. The magnetic recording medium according to claim 1, wherein the sol component ratio in the magnetic layer is equal to or less than 3.0 percent.

7. A method of reproducing magnetic signals, comprising:
reproducing magnetic signals that have been recorded on the magnetic recording medium according to claim 1 with a reproduction head with a track width of equal to or less than 4.0 μm.

8. A magnetic signal reproduction system, comprising:
the magnetic recording medium according to claim 1, and
a reproduction head with a track width of equal to or less than 4.0 μm.
